(19) United States
(12) Patent Application Publication
(10) Pub. No.: US 2025/0131660 A1
(43) Pub. Date: Apr. 24, 2025

(54) DISPLAYING INFORMATION BASED ON GAZE

(71) Applicant: QUALCOMM Incorporated, San Diego, CA (US)

(72) Inventors: Venkata Ravi Kiran DAYANA, San Diego, CA (US); Hau HWANG, San Diego, CA (US)

(21) Appl. No.: 18/399,298

(22) Filed: Dec. 28, 2023

Related U.S. Application Data
(60) Provisional application No. 63/591,704, filed on Oct. 19, 2023.

(51) Int. Cl. G06T 19/00; G06F 3/01; G06F 3/16; G06F 40/40; G06V 10/764

(52) U.S. Cl. CPC G06T 19/006; G06F 3/012; G06F 3/013; G06F 3/017; G06F 3/167; G06F 40/40; G06V 10/764

(57) ABSTRACT

Systems and techniques are described herein for displaying information. For instance, a device for displaying information is provided. The device may include at least one memory; and at least one processor coupled to the at least one memory and configured to: detect an object in an image of a scene obtained from a first camera; determine that a user is gazing at a representation of the object displayed at a display based on an image of the user obtained from a second camera; and based on determining that the user is gazing at the representation of the object displayed at the display, display, via the display, information associated with the object.

### CROSS-REFERENCE TO RELATED APPLICATIONS

This application claims priority to U.S. Provisional Patent Application No. 63/591,704, filed Oct. 19, 2023, which is hereby incorporated by reference, in its entirety and for all purposes.

### TECHNICAL FIELD

The present disclosure generally relates to displaying information. For example, aspects of the present disclosure include systems and techniques for displaying information based on gaze (e.g., a gaze of a user).

### BACKGROUND

A device may use a display to provide information visually, for example, by displaying images, videos, and/or text. Many devices include displays; the displays may be an important way that such devices provide information to users. For example, smart phones, tablets, and extended reality (XR) devices (including augmented reality (AR) devices, mixed reality (MR) devices, and virtual reality (VR) devices) include displays.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for displaying information. According to at least one example, a method is provided for displaying information. The method includes: detecting an object in an image of a scene obtained from a first camera; determining that a user is gazing at a representation of the object displayed at a display based on an image of the user obtained from a second camera; and based on determining that the user is gazing at the representation of the object displayed at the display, displaying, via the display, information associated with the object.

In another example, an apparatus for displaying information is provided that includes at least one memory and at least one processor (e.g., configured in circuitry) coupled to the at least one memory. The at least one processor configured to: detect an object in an image of a scene obtained from a first camera; determine that a user is gazing at a representation of the object displayed at a display based on an image of the user obtained from a second camera; and based on determining that the user is gazing at the representation of the object displayed at the display, display, via the display, information associated with the object.

In another example, a non-transitory computer-readable medium is provided that has stored thereon instructions that, when executed by one or more processors, cause the one or more processors to: detect an object in an image of a scene obtained from a first camera; determine that a user is gazing at a representation of the object displayed at a display based on an image of the user obtained from a second camera; and based on determining that the user is gazing at the representation of the object displayed at the display, display, via the display, information associated with the object.

In another example, an apparatus for displaying information is provided. The apparatus includes: means for detecting an object in an image of a scene obtained from a first camera; means for determining that a user is gazing at a representation of the object displayed at a display based on an image of the user obtained from a second camera; and means for based on determining that the user is gazing at the representation of the object displayed at the display, displaying, via the display, information associated with the object.

In another example, an apparatus for displaying information is provided that includes a first camera; a second camera; a display; at least one memory; and at least one processor coupled to the at least one memory and configured to: detect an object in an image of a scene obtained from the first camera; determine that a user is gazing at a representation of the object displayed at the display based on an image of the user obtained from the second camera; and based on determining that the user is gazing at the representation of the object displayed at the display, display, via the display, information associated with the object.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example extended-reality (XR) system, according to aspects of the disclosure;

FIG. 2 is a diagram illustrating another example extended reality (XR) system, according to aspects of the disclosure;

FIG. 3 is a diagram illustrating yet another example extended-reality (XR) system, according to aspects of the disclosure;

FIG. 4 is a block diagram illustrating an architecture of an example extended reality (XR) system, in accordance with some aspects of the disclosure;

FIG. 5 is a diagram illustrating an example environment in which an example device may display information based on a gaze of a user, according to various aspects of the present disclosure;

FIG. 6 is a diagram illustrating another example environment in which an example device may display information based on a gaze of a user, according to various aspects of the present disclosure;

FIG. 7 is a block diagram illustrating an example device for displaying information based on a user's gaze, according to various aspects of the present disclosure;

FIG. 8 is a flow diagram illustrating another example process for displaying information based on a user's gaze, in accordance with aspects of the present disclosure;

FIG. 9 is a block diagram illustrating an example of a deep learning neural network that can be used to perform various tasks, according to some aspects of the disclosed technology;

FIG. 10 is a block diagram illustrating an example of a convolutional neural network (CNN), according to various aspects of the present disclosure; and

FIG. 11 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application.

However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Extended reality (XR) systems can include virtual reality (VR) systems facilitating interactions with VR environments, augmented reality (AR) systems facilitating interactions with AR environments, mixed reality (MR) systems facilitating interactions with MR environments, and/or other XR systems. For instance, VR provides a complete immersive experience in a three-dimensional (3D) computer-generated VR environment or video depicting a virtual version of a real-world environment. VR content can include VR video in some cases, which can be captured and rendered at very high quality, potentially providing a truly immersive virtual reality experience. Virtual reality applications can include gaming, training, education, sports video, online shopping, among others. VR content can be rendered and displayed using a VR system or device, such as a VR HMD or other VR headset, which fully covers a user's eyes during a VR experience.

AR is a technology that provides virtual or computer-generated content (referred to as AR content) over the user's view of a physical, real-world scene or environment. AR content can include any virtual content, such as text, video, images, graphic content, location data (e.g., global positioning system (GPS) data or other location data), sounds, any combination thereof, and/or other augmented content. An AR system is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a real-world pig), by AR content displayed relative to the physical object (e.g., informational virtual content displayed near a sign on a building, a virtual monster anchored to (e.g., placed on top of) a real-world table in one or more images, etc.), and/or by displaying other types of AR content. Various types of AR systems can be used for gaming, entertainment, and/or other applications.

MR technologies can combine aspects of VR and AR to provide an immersive experience for a user. For example, in an MR environment, real-world and computer-generated objects can interact (e.g., a real person can interact with a virtual person as if the virtual person were a real person). Additionally, or alternatively, MR can include a VR headset with AR capabilities, for instance, an MR system may perform video pass-through (to mimic AR glasses) by passing images (and/or video) of some real-world objects, like a keyboard and/or a monitor, and/or taking real-word geometry (e.g., walls, tables) into account. For example, in a game, the structure of a room can be retextured to according to the game, but the geometry may still be based on the real-world geometry of the room.

In some cases, an XR system can include an optical “see-through” or “pass-through” display (e.g., see-through or pass-through AR HMD or AR glasses), allowing the XR system to display XR content (e.g., AR content) directly onto a real-world view without displaying video content. For example, a user may view physical objects through a display (e.g., glasses or lenses), and the AR system can display AR content onto the display to provide the user with an enhanced visual perception of one or more real-world objects. In one example, a display of an optical see-through AR system can include a lens or glass in front of each eye (or a single lens or glass over both eyes). The see-through display can allow the user to see a real-world or physical object directly, and can display (e.g., projected or otherwise displayed) an enhanced image of that object or additional AR content to augment the user's visual perception of the real world.

An XR system may display visual information (e.g., text, images, and/or video) at a display partially, mostly, or entirely, filling a user's field of view (e.g., using a see-through or pass-through display). XR systems typically include a display (e.g., a head-mounted display (HMD) or smart glasses), an image-capture device proximate to the display, and a processing device. In such XR systems, the image-capture device may capture images indicative of a field of view of user, the processing device may determine, or obtain, visual information to display based on the field of view of the user and/or objects within the field of view, and the display may display the virtual content within the field of view of the user.

Many devices, including, as examples, handheld devices (including smart phones and tablets) and extended reality (XR) devices (including augmented reality (AR) devices, mixed reality (MR) devices, and virtual reality (VR) devices) include displays. Such devices may use their respective displays to display visual information, such as images, videos, and/or text to users.

Users may interact with such devices through a variety of interfaces, such as buttons on the devices, buttons on attached or remote controllers, and/or touch screens. In some cases, it may be difficult, or inconvenient, for a user to use such interfaces. For example, if a user is holding a handheld device, and viewing a scene through the handheld device (e.g., in a pass-through display mode of operation), it may be difficult or inconvenient for the user to touch a touch screen of the handheld device. Additionally, touching such a touch screen may occlude part of the display while the user touches the touch screen, which may be undesirable. As another example, if a user is wearing a head-mounted display (HMD) of an XR device, the user may not wish to hold a controller. Further, buttons on such an HMD may be inconvenient because such buttons may be small and/or not in the view of the user while the user is wearing the HMD.

Systems, apparatuses, methods (also referred to as processes), and computer-readable media (collectively referred to herein as “systems and techniques”) are described herein for displaying information based on a user's gaze. The systems and techniques described herein may detect a gaze of a user and determine to display information based on the gaze of the user.

For example, the systems and techniques may be implemented in an XR device. The systems and techniques may enable the XR device to receive inputs from a user based on the user's eyes (e.g., based on the user's gaze). For example, a user may use an XR device in an AR or MR capacity (e.g., allowing the user to view a scene and visual information displayed by the XR device, for example, using a see-through display or a pass-through display). The systems and techniques may determine what the user is gazing at in the scene (through a see-through display or in a representation of the scene of a pass-through display). The systems and techniques may further determine information to display based on what the user is gazing at.

As another example, the systems and techniques may be implemented in a handheld device (e.g., a smart phone or a tablet). The systems and techniques may enable the handheld device to receive inputs from a user based on the user's eyes. For example, a user may use a handheld device in an AR or MR capacity (e.g., allowing the user to view a scene and visual information displayed by the handheld device using the display of the device in a pass-through mode of operation). The systems and techniques may determine what the user is gazing at in the scene (e.g., through the handheld device in the pass-through mode of operation). The systems and techniques may further determine information to display based on what the user is gazing at.

For instance, if the user is gazing at text in a first language, the systems and techniques may determine to translate the text into a second language (e.g., from a language that the user cannot interpret into a language the user can interpret). As another example, if the user is gazing at a barcode of a product, the systems and techniques may determine to display information from an internet search for the product (e.g., price information and/or reviews). As yet another example, if the user is gazing at a quick response (QR) code or universal resource locator (URL) of a website, the systems and techniques may determine to display information from the website.

In another example, if the user is gazing at contact information, for example, a phone number, an email address, or a social-media handle, the systems and techniques may determine to display information regarding a communication. For instance, the systems and techniques may determine to display a query regarding calling the phone number, a draft text message to the phone number, a draft email addressed to the email address, a draft social-media message relative to the social-media handle, or a query regarding saving the contact information.

As yet another example if the user is gazing at an object or person, the systems and techniques may determine to display an identifier of the object or person (e.g., a name or label of the object or person) to the user. The identifier may be in a language selected by the user, for example, a language of the user or a language the user is learning.

As yet another example, if the user is gazing at an object, the systems and techniques may determine to display information related to logging the object. For example, the user May be gazing at food the user intends to eat. The systems and techniques may display a query regarding logging the food (e.g., using a food-consumption application). Additionally or alternatively, the user may be taking inventory of objects. The systems and techniques may determine to display a count of the objects and/or a query regarding logging the count of the objects.

As yet another example, two users may be viewing a scene. At least one of the users may be viewing the scene through a display. The display may be a see-through display or a pass-through display. Alternatively, a scene-facing camera may capture images and/or video of the scene and display the images and/or video at the display whether the display is in the scene or not. For example, the scene-facing camera may be in the scene at one location and the display may be at another location. Such a configuration may be referred to as a remote pass-through configuration. The systems and techniques may further include one or more user-facing cameras that may capture images of one or both users (specifically the eyes of the users. The systems and techniques may determine the gaze of one or both of the users and determine information to display at the display based on the gaze. For example, a parent may be viewing a scene with a child. The child may be gazing at the scene through a display (e.g., in a see-through display configuration, a pass-through display configuration, or a remote pass-through configuration). The systems and techniques may capture images of the eyes of the parent and determine a gaze of the parent. The systems and techniques may further determine objects in the scene. The systems and techniques may determine that the parent is gazing at a particular object in the scene. The systems and techniques may determine to display information relative to the particular object at the display (e.g., for the child to view) based on the gaze of the parent.

The systems and techniques (according to the above-described examples or in other use cases) may display the information overlaid onto what the user is gazing at (e.g., in the user's field of view between the user's eyes and what the user is gazing at in the scene) using either a see-through display or a pass-through display. For example, if the user is gazing at text in a language not known to the user, the systems and techniques may overlay the text with translated text in a language known to the user. As another example, if the user is gazing at an object, the systems and techniques may display an identifier of the object overlaid onto the object in a field of view of the user.

Additionally or alternatively, the systems and techniques may display the information proximate to what the user is gazing at (e.g., beside what the user is gazing at) in the user's field of view. In some aspects, the systems and techniques may display the information overlaid onto a background of the scene (e.g., as determined using depth-detection techniques such as time-of-flight techniques, stereoscopic-imaging techniques, structured-light techniques, and/or monocular-depth detection techniques). In some aspects, the systems and techniques may display the information overlaid onto a visually uniform portion of the scene (e.g., a blank wall as determined by an analysis of an image of the scene). In some aspects, the systems and techniques may display the information overlaid onto an uninteresting portion of the scene (e.g., as determined by tracking the gaze of the user over time).

Additionally or alternatively, the systems and techniques may determine to cease displaying information, and/or to determine to not display information based on the gaze of the user. For example, if the user is gazing at an object in a scene, the systems and techniques may determine to display information based on determining that the user gazing at the object. The user may cease gazing at the object; for example, the user may gaze at another object in the scene. The systems and techniques may determine that the user is no longer gazing at the object and determine to cease displaying the information based on the user no longer gazing at the object. Additionally or alternatively, the systems and techniques may determine to display other information based on the user gazing at the other object in the scene.

In some aspects, the systems and techniques may initiate an action responsive to determining that the user is interested in an object in a scene. The action may be based on the object. In some aspects, the systems and techniques may initiate the action further responsive to an instruction from the user. In some cases, the information displayed at the display may be a prompt for the instruction. In some aspects, the systems and techniques may interpret a vocalization of the user, a hand gesture of the user, a head motion of the user, and/or an eye motion of the user as the instruction.

For example, responsive to determining that the user is interested in text in a scene (e.g., based on the user gazing at the text), the systems and techniques may display information related to the text (e.g., a translation of the text or information from an internet search based on the text). The systems and techniques may detect a hand gesture of the user (e.g., based on images of hands of the user) or a head motion of the user (e.g., based on data from an inertial measurement unit (IMU) of a head-mounted display). The systems and techniques may interpret the hand gesture or the head motion as an indication that the user wants to hear the text (or the information related to the text) vocalized. Responsive to interpreting the hand gesture or the head motion, the systems and techniques may produce audio of the text being vocalized.

As another example, responsive to determining that a user is interested in a barcode in a scene, the systems and techniques may display information about a product associated with the barcode (e.g., a price of the product from an online retailer). The systems and techniques may detect a vocalization of the user and interpret the vocalization as an indication that the user wishes to buy the product from the online retailer. Responsive to interpreting the vocalization, the systems and techniques may initiate a transaction to purchase the product from the online retailer.

As yet another example, responsive to determining that a user is interested in a phone number in a scene, the systems and techniques may display a prompt querying the user regarding whether the user wants to save the phone number or call the phone number. The systems and techniques may detect an eye motion of the user (e.g., blinks and/or continued gazing at the phone number). The systems and techniques may interpret the eye motion as an indication that the user wants to call the phone number. Responsive to interpreting the eye motion, the systems and techniques may initiate a phone call to the phone number.

In some aspects, the systems and techniques may be implemented in a device including a scene-facing camera, a user-facing camera, and a display. The scene-facing camera may capture images of the scene and the systems and techniques may identify objects in the scene based on the images of the scene. The user-facing camera may capture images of the user (e.g., of the user's eyes) and the systems and techniques may determine a gaze of the user based on the images of the user. The systems and techniques may determine that the user is interested in an object of the objects identified in the scene based on the gaze of the user. For example, the systems and techniques may compare the gaze of the user relative to the scene with locations of objects in the scene. Having determined that the user is interested in an object, the systems and techniques may determine information to display to the user based on the user's interest. The systems and techniques may further display the information at the display. The display may be positioned in a field of view of the user between the user's eyes and the scene (e.g., such that the systems and techniques may display the information overlaid onto the object in the field of view of the user).

By displaying information based on a gaze of a user, the systems and techniques may enable devices (e.g., XR devices and handheld devices) to receive inputs from users in ways that are more convenient for the users than other interfaces, such as buttons and touch screens. As such, devices implementing the systems and techniques may be more convenient to use than other devices.

Various aspects of the application will be described with respect to the figures below.

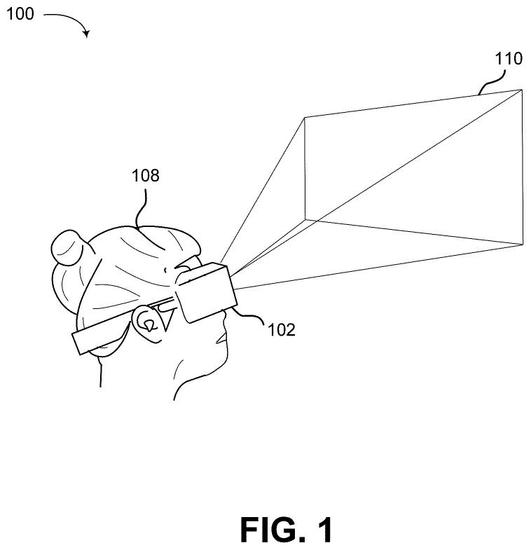

FIG. 1 is a diagram illustrating an example extended-reality (XR) system 100, according to aspects of the disclosure. As shown, XR system 100 includes an XR device 102. XR device 102 may implement, as examples, image-capture, object-detection, gaze-tracking, view-tracking, computational and/or display aspects of extended reality, including virtual reality (VR), augmented reality (AR), and/or mixed reality (MR). For example, XR device 102 may include one or more scene-facing cameras that may capture images of a scene in which user 108 uses XR device 102. XR device 102 may detect objects in the scene based on the images of the scene. Further, XR device 102 may include one or more user-facing cameras that may capture images of eyes of user 108. XR device 102 may determine a gaze of user 108 based on the images of user 108. XR device 102 may determine an object of interest in the scene based on the gaze of user 108. XR device 102 may obtain and/or render information (e.g., text, images, and/or video based on the object of interest). XR device 102 may display the information to a user 108 (e.g., within a field of view 110 of user 108).

XR device 102 may display the information to be viewed by a user 108 in field of view 110 of user 108. For example, in a “see-through” configuration, XR device 102 may include a transparent surface (e.g., optical glass) such that information may be displayed on (e.g., by being projected onto) the transparent surface to overlay the information onto the scene as viewed through the transparent surface. In a “pass-through” configuration, XR device 102 may include a scene-facing camera that may capture images of the scene of user 108. XR device 102 may display the captured images or video of the scene, as captured by the scene-facing camera, and information overlaid on the images or video of the scene.

In various examples, XR device 102 may be, or may include, a head-mounted display (HMD), a virtual reality headset, and/or smart glasses. XR device 102 may include one or more cameras, including scene-facing cameras and/or user-facing cameras, a GPU, one or more sensors (e.g., such as one or more inertial measurement units (IMUs), image sensors, and/or microphones), and/or one or more output devices (e.g., such as speakers, display, and/or smart glass).

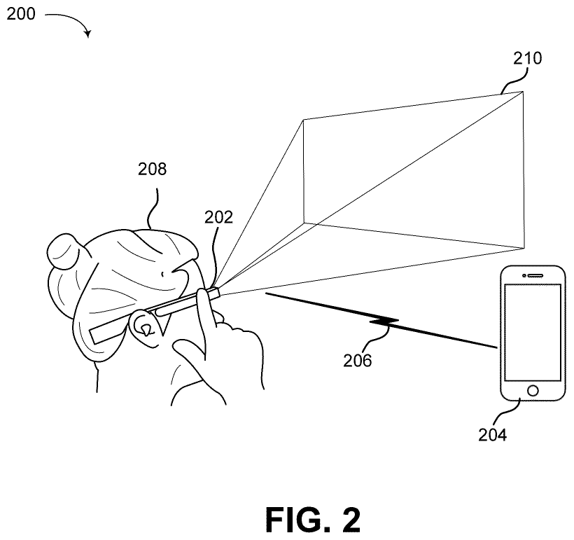

FIG. 2 is a diagram illustrating an example extended reality (XR) system 200, according to aspects of the disclosure. As shown, XR system 200 includes an XR device 202, a companion device 204, and a communication link 206 between XR device 202 and companion device 204. XR device 202 may implement, as examples, image-capture, view-tracking, and/or display aspects of extended reality, including virtual reality (VR), augmented reality (AR), and/or mixed reality (MR). For example, XR device 202 may include one or more scene-facing cameras that may capture images of a scene in which a user 208 uses XR device 202. Further, XR device 202 may include one or more user-facing cameras that may capture images of eyes of user 208. XR device 202 may provide the images of the scene and/or the images of user 208 to companion device 204 (e.g., via communication link 206).

Companion device 204 may implement computing aspects of extended reality, including, as examples, object detection, gaze tracking, information gathering and/or information generation. For example, companion device 204 may receive images of the scene and/or of the eyes of user 208. Companion device 204 may detect objects in the scene based on received images of the scene. Further, companion device 204 may determine the gaze of user 208 based on received images of user 208 (e.g., of eyes of user 208). Companion device 204 may determine an object of interest in the scene based on the gaze of user 208. Companion device 204 may obtain and/or render information (e.g., text, images, and/or video based on the object of interest). Companion device 204 may provide the information to XR device 202 (e.g., via communication link 206). XR device 202 may display the information to a user 208 (e.g., within a field of view 210 of user 208).

XR device 202 may display the information to be viewed by a user 208 in field of view 210 of user 208. For example, in a “see-through” configuration, XR device 202 may include a transparent surface (e.g., optical glass) such that information may be displayed on (e.g., by being projected onto) the transparent surface to overlay the information onto the scene as viewed through the transparent surface. In a “pass-through” configuration, XR device 202 may include a scene-facing camera that may capture images of the scene of user 208. XR device 202 may display the captured images or video of the scene, as captured by the scene-facing camera, and information overlaid on the images or video of the scene.

In various examples, XR device 202 may be, or may include, a head-mounted display (HMD), a virtual reality headset, and/or smart glasses. XR device 202 may include one or more cameras, including scene-facing cameras and/or user-facing cameras, a GPU, one or more sensors (e.g., such as one or more inertial measurement units (IMUs), image sensors, and/or microphones), and/or one or more output devices (e.g., such as speakers, display, and/or smart glass). Companion device 204 may be, or may include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof. Communication link 206 may be a wireless connection according to any suitable wireless protocol, such as, for example, Institute of Electrical and Electronics Engineers (IEEE) 802.11 (Wi-Fi), IEEE 802.15, or Bluetooth®. In some cases, communication link 206 may be a direct wireless connection between XR device 202 and companion device 204. In other cases, communication link 206 may be through one or more intermediary devices, such as, for example, routers or switches and/or across a network.

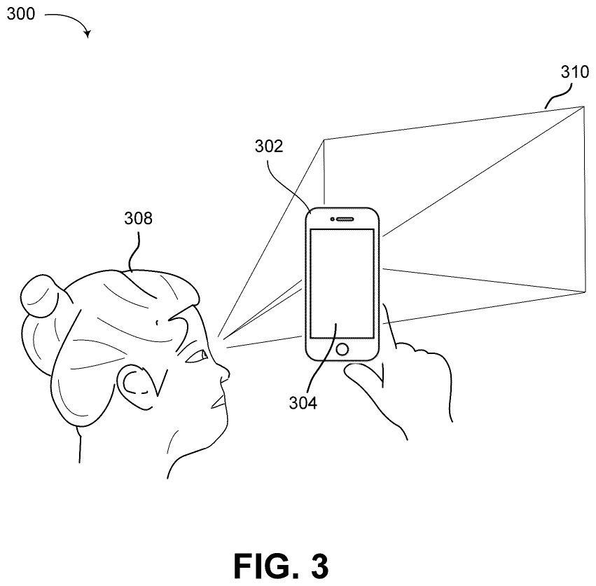

FIG. 3 is a diagram illustrating an example extended-reality (XR) system 300, according to aspects of the disclosure. As shown, XR system 300 includes a handheld device 302 including a display 304. In some cases, handheld device 302 may implement, as examples, image-capture, object detection, gaze-tracking, view-tracking, computational and/or display aspects of extended reality, including virtual reality (VR), augmented reality (AR), and/or mixed reality (MR). For example, handheld device 302 may include one or more scene-facing cameras that may capture images of a scene in which a user 308 uses handheld device 302. Handheld device 302 may detect objects in the scene based on the images of the scene. Further, handheld device 302 may include one or more user-facing cameras that may capture images of eyes of user 308. Handheld device 302 may determine a gaze of user 308 based on the images of user 308. Handheld device 302 may determine an object of interest in the scene based on the gaze of user 308. Handheld device 302 may obtain and/or render information (e.g., text, images, and/or video based on the object of interest). Handheld device 302 may display the information to a user 308 at display 304 (e.g., within a field of view 310 of user 308).

Handheld device 302 may display the information to be viewed by a user 308 in field of view 310 of user 308. Handheld device 302 may operate in a “pass-through” configuration. For example, handheld device 302 may include a scene-facing camera that may capture images of the scene of user 308. Handheld device 302 may display the captured images or video of the scene, as captured by the scene-facing camera, and information overlaid on the images or video of the scene. Handheld device 302 may display the information to be viewed by a user 308 in field of view 310 of user 308. As another example, in “see-through” configuration, handheld device 302 may include a transparent surface (e.g., optical glass) such that information may be displayed on the transparent surface to overlay the information onto the scene as viewed through the transparent surface.

Handheld device 302 and/or display 304 may be, or may include, a handheld device, a smartphone, a tablet, or another computing device with a display. Handheld device 302 include one or more cameras, including scene-facing cameras and/or user-facing cameras, a GPU, one or more sensors (e.g., such as one or more inertial measurement units (IMUs), image sensors, and/or microphones), and/or one or more output devices (e.g., such as speakers, display, and/or smart glass).

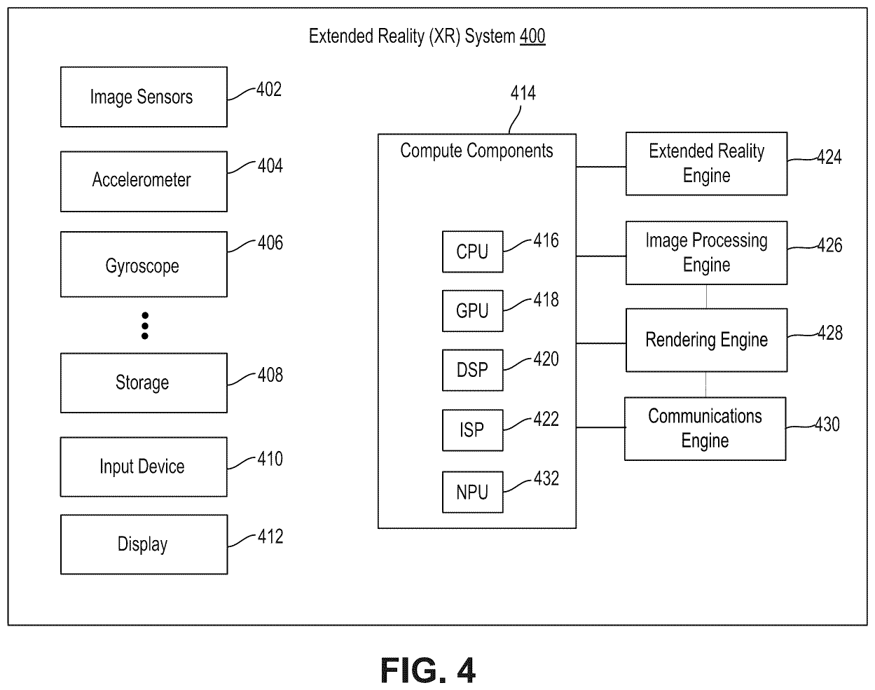

FIG. 4 is a diagram illustrating an architecture of an example extended reality (XR) system 400, in accordance with some aspects of the disclosure. XR system 400 may execute XR applications and implement XR operations. For example, XR system 400 may implement, as examples, image-capture, object detection, gaze-tracking, view-tracking, computational and/or display aspects of extended reality, including virtual reality (VR), augmented reality (AR), and/or mixed reality (MR). Any of XR system 100 of FIG. 1, XR system 200 of FIG. 2, and/or XR system 300 of FIG. 3 may implement the architecture of XR system 400 of FIG. 4.

In this illustrative example, XR system 400 includes one or more image sensors 402, an accelerometer 404, a gyroscope 406, storage 408, an input device 410, a display 412, Compute components 414, an XR engine 424, an image processing engine 426, a rendering engine 428, and a communications engine 430. It should be noted that the components 402-432 shown in

FIG. 4 are non-limiting examples provided for illustrative and explanation purposes, and other examples may include more, fewer, or different components than those shown in FIG. 4. For example, in some cases, XR system 400 may include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors, audio sensors, etc.), one or more display devices, one more other processing engines, one or more other hardware components, and/or one or more other software and/or hardware components that are not shown in FIG. 4. While various components of XR system 400, such as image sensors 402, may be referenced in the singular form herein, it should be understood that XR system 400 may include multiple of any component discussed herein (e.g., multiple image sensors 402).

Display 412 may be, or may include, a glass, a screen, a lens, a projector, and/or other display mechanism that allows a user to see the real-world environment and also allows XR content to be overlaid, overlapped, blended with, or otherwise displayed thereon.

XR system 400 may include, or may be in communication with, (wired or wirelessly) an input device 410. Input device 410 may include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device discussed herein, or any combination thereof. In some cases, image sensors 402 may capture images that may be processed for interpreting gesture commands.

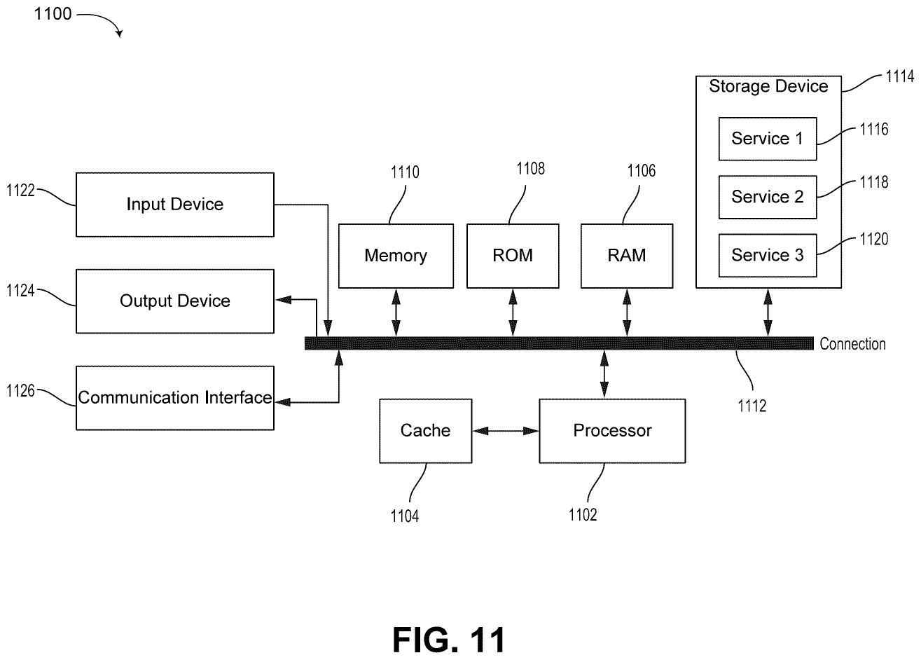

XR system 400 may also communicate with one or more other electronic devices (wired or wirelessly). For example, communications engine 430 may be configured to manage connections and communicate with one or more electronic devices. In some cases, communications engine 430 may correspond to communication interface 1126 of FIG. 11.

In some implementations, image sensors 402, accelerometer 404, gyroscope 406, storage 408, display 412, compute components 414, XR engine 424, image processing engine 426, and rendering engine 428 may be part of the same computing device. For example, in some cases, image sensors 402, accelerometer 404, gyroscope 406, storage 408, display 412, compute components 414, XR engine 424, image processing engine 426, and rendering engine 428 May be integrated into an HMD, extended reality glasses, smartphone, laptop, tablet computer, gaming system, and/or any other computing device. However, in some implementations, image sensors 402, accelerometer 404, gyroscope 406, storage 408, display 412, compute components 414, XR engine 424, image processing engine 426, and rendering engine 428 may be part of two or more separate computing devices. For instance, in some cases, some of the components 402-432 may be part of, or implemented by, one computing device and the remaining components may be part of, or implemented by, one or more other computing devices. For example, such as in a split perception XR system, XR system 400 may include a first device (e.g., an HMD), including display 412, image sensors 402, accelerometer 404, gyroscope 406, and/or one or more compute components 414. XR system 400 may also include a second device including additional compute components 414 (e.g., implementing XR engine 424, image processing engine 426, rendering engine 428, and/or communications engine 430). In such an example, the second device may generate virtual content based on information or data (e.g., images, sensor data such as measurements from accelerometer 404 and gyroscope 406) and may provide the virtual content to the first device for display at the first device. The second device may be, or may include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof.

Storage 408 may be any storage device(s) for storing data. Moreover, storage 408 may store data from any of the components of XR system 400. For example, storage 408 may store data from image sensors 402 (e.g., image or video data), data from accelerometer 404 (e.g., measurements), data from gyroscope 406 (e.g., measurements), data from compute components 414 (e.g., processing parameters, preferences, virtual content, rendering content, scene maps, tracking and localization data, object detection data, privacy data, XR application data, face recognition data, occlusion data, etc.), data from XR engine 424, data from image processing engine 426, and/or data from rendering engine 428 (e.g., output frames). In some examples, storage 408 may include a buffer for storing frames for processing by compute components 414.

Compute components 414 may be, or may include, a central processing unit (CPU) 416, a graphics processing unit (GPU) 418, a digital signal processor (DSP) 420, an image signal processor (ISP) 422, a neural processing unit (NPU) 432, which may implement one or more trained neural networks, and/or other processors. Compute components 414 may perform various operations such as image enhancement, computer vision, graphics rendering, extended reality operations (e.g., tracking, localization, pose estimation, mapping, content anchoring, content rendering, predicting, etc.), image and/or video processing, sensor processing, recognition (e.g., text recognition, facial recognition, object recognition, feature recognition, tracking or pattern recognition, scene recognition, occlusion detection, etc.), trained machine-learning operations, filtering, and/or any of the various operations described herein. In some examples, compute components 414 may implement (e.g., control, operate, etc.) XR engine 424, image processing engine 426, and rendering engine 428. In other examples, compute components 414 may also implement one or more other processing engines.

Image sensors 402 may include any image and/or video sensors or capturing devices. In some examples, image sensors 402 may be part of a multiple-camera assembly, such as a dual-camera assembly. Image sensors 402 may include one or more scene-facing cameras and one or more user-facing cameras. For example, image sensors 402 may include one or more scene-facing cameras configured to face toward a scene (e.g., away from a user). Further, image sensors 402 may include one or more user-facing cameras configured to face toward a user. The user-facing cameras may be configured to capture images of eyes of the user. Image sensors 402 may capture image and/or video content (e.g., raw image and/or video data), which may then be processed by compute components 414, XR engine 424, image processing engine 426, and/or rendering engine 428 as described herein.

In some examples, image sensors 402 may capture image data and may generate images (also referred to as frames) based on the image data and/or may provide the image data or frames to XR engine 424, image processing engine 426, and/or rendering engine 428 for processing. An image or frame may include a video frame of a video sequence or a still image. An image or frame may include a pixel array representing a scene. For example, an image may be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image. In some aspects, image sensors 402 may include infrared (IR) sensors that may capture light outside the visible spectrum. IR sensors may be useful for low-light settings. As an example, XR system 400 may include an HMD (e.g., including display 412) that may include baffles to block light from a scene from reaching eyes of a user. As another example, XR system 400 may include sunglasses (e.g., including display 412) that may block light from a scene from reaching eyes of a user. Image sensors 402 may include IR sensors (e.g., user-facing IR sensors) to capture images of the eyes of the user despite light from the scene being blocked.

In some cases, image sensors 402 (and/or other camera of XR system 400) may be configured to also capture depth information. For example, in some implementations, image sensors 402 (and/or other camera) may include an RGB-depth (RGB-D) camera. In some cases, XR system 400 may include one or more depth sensors (not shown) that are separate from image sensors 402 (and/or other camera) and that may capture depth information. For instance, such a depth sensor may obtain depth information independently from image sensors 402. In some examples, a depth sensor may be physically installed in the same general location or position as image sensors 402 but may operate at a different frequency or frame rate from image sensors 402. In some examples, a depth sensor may take the form of a light source that may project a structured or textured light pattern, which may include one or more narrow bands of light, onto one or more objects in a scene. Depth information may then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

XR system 400 may also include other sensors in its one or more sensors. The one or more sensors may include one or more accelerometers (e.g., accelerometer 404), one or more gyroscopes (e.g., gyroscope 406), and/or other sensors. The one or more sensors may provide velocity, orientation, and/or other position-related information to compute components 414. For example, accelerometer 404 may detect acceleration by XR system 400 and may generate acceleration measurements based on the detected acceleration. In some cases, accelerometer 404 may provide one or more translational vectors (e.g., up/down, left/right, forward/back) that may be used for determining a position or pose of XR system 400. Gyroscope 406 may detect and measure the orientation and angular velocity of XR system 400. For example, gyroscope 406 may be used to measure the pitch, roll, and yaw of XR system 400. In some cases, gyroscope 406 may provide one or more rotational vectors (e.g., pitch, yaw, roll). In some examples, image sensors 402 and/or XR engine 424 may use measurements obtained by accelerometer 404 (e.g., one or more translational vectors) and/or gyroscope 406 (e.g., one or more rotational vectors) to calculate the pose of XR system 400. As previously noted, in other examples, XR system 400 may also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors may include at least one IMU. An IMU is an electronic device that measures the specific force, angular rate, and/or the orientation of XR system 400, using a combination of one or more accelerometers, one or more gyroscopes, and/or one or more magnetometers. In some examples, the one or more sensors may output measured information associated with the capture of an image captured by image sensors 402 (and/or other camera of XR system 400) and/or depth information obtained using one or more depth sensors of XR system 400.

The output of one or more sensors (e.g., accelerometer 404, gyroscope 406, one or more IMUs, and/or other sensors) can be used by XR engine 424 to determine a pose of XR system 400 (also referred to as the head pose) and/or the pose of image sensors 402 (or other camera of XR system 400). In some cases, the pose of XR system 400 and the pose of image sensors 402 (or other camera) can be the same. The pose of image sensors 402 refers to the position and orientation of image sensors 402 relative to a frame of reference (e.g., with respect to a field of view 210 of FIG. 2). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees of Freedom (3DoF), which refers to the three angular components (e.g. roll, pitch, and yaw).

In some cases, a device tracker (not shown) can use the measurements from the one or more sensors and image data from image sensors 402 to track a pose (e.g., a 6DoF pose) of XR system 400. For example, the device tracker can fuse visual data (e.g., using a visual tracking solution) from the image data with inertial data from the measurements to determine a position and motion of XR system 400 relative to the physical world (e.g., the scene) and a map of the physical world. As described below, in some examples, when tracking the pose of XR system 400, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of XR system 200 within the scene and the 3D map of the scene, etc. The 3D map can provide a digital representation of a scene in the real/physical world. In some examples, the 3D map can anchor position-based objects and/or content to real-world coordinates and/or objects. XR system 200 can use a mapped scene (e.g., a scene in the physical world represented by, and/or associated with, a 3D map) to merge the physical and virtual worlds and/or merge virtual content or objects with the physical environment.

In some cases, the XR system 400 can also track the hand and/or fingers of the user to allow the user to interact with and/or control virtual content in a virtual environment. For example, the XR system 400 can track a pose and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

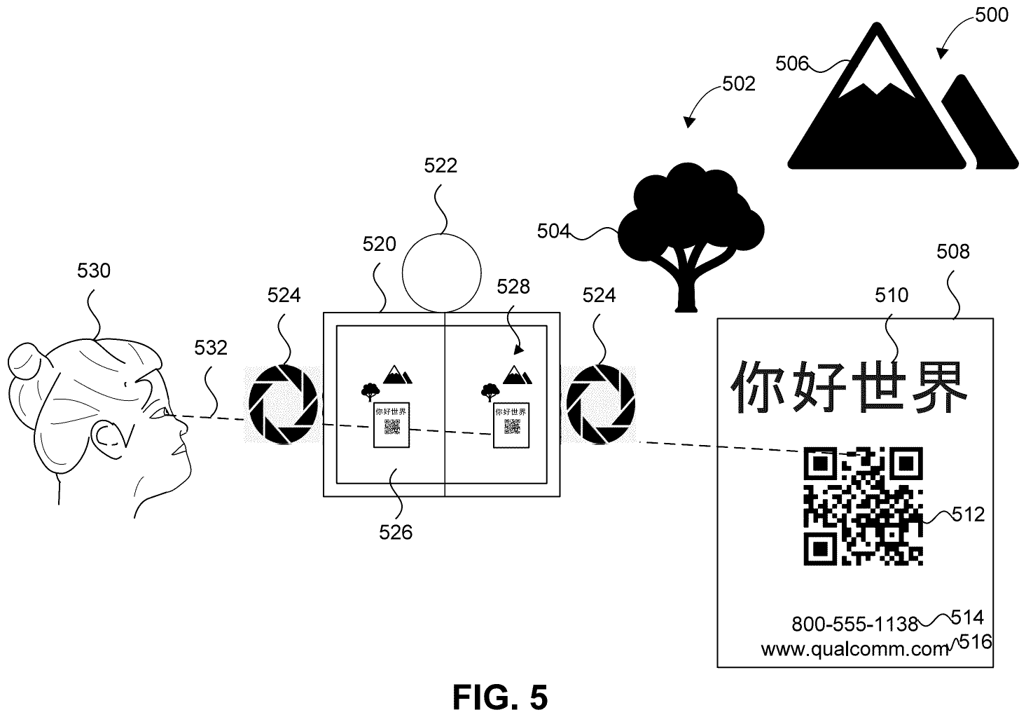

FIG. 5 is a diagram illustrating an example environment 500 in which an example device 520 may display information 528 based on a gaze 532 of a user 530, according to various aspects of the present disclosure. In general, device 520 may use one or more scene-facing camera(s) 522 to capture images of scene 502. Device 520 may detect objects in the images of scene 502 (e.g., object 504, object 506, object 508, text 510, quick response (QR) code 512, and/or universal resource locator (URL) 516). Further, device 520 may use one or more user-facing camera(s) 524 to capture images of eyes of user 530. Device 520 may track gaze 532 of user 530. Device 520 may determine an object of interest to user 530 based on gaze 532 of user 530. Device 520 may then determine information 528 to display at display 526 based on the object of interest.

Scene 502 may include any scene, indoor or outdoor. Scene 502 may be, or may include, anything captured by images of scene-facing camera(s) 522. Scene 502 may include any number of objects such as people, animals, vehicles, buildings, mountains, trees, signs, documents, text, QR codes, bar codes, contact information, URLs, etc. For example, as illustrated in FIG. 5, scene 502 may include several objects in a foreground or background of an image. Alternatively, in some cases, scene 502 may include one object, (e.g., a document). In such cases, the one object may include more objects (e.g., or more pieces of text). Objects may be, or may include, anything detectable as an object by device 520. Object 504, object 506, object 508, text 510, QR code 512, phone number 514, and URL 516 are provided as examples of objects.

Device 520 may be an XR device or a handheld device (e.g., that may implement AR or MR). Device 520 may be, or may include, a head-mounted display (HMD), a virtual reality headset, and/or smart glasses, for example, XR device 102 of FIG. 1 and/or XR device 202 and companion device 204 of FIG. 2 may be examples of device 520. Alternatively, device 520 may be, or may include, a handheld device, a smartphone, a tablet, or another computing device with a display, for example, handheld device 302 of FIG. 3 may be an example of device 520. Further, device 520 may implement the architecture of XR system 400 of FIG. 4. In some aspects (e.g., when device 520 is implemented as a HMD, VR headset, or smart glasses), display 526 may include two screens or lenses for displaying images according to stereoscopic-depth principles. Alternatively, in some aspects (e.g., when device 520 is implemented as a handheld device), device 520 may include a single display. In either cases, device 520 may implement AR or MR by displaying information (e.g., text, images, and/or video) in the field of view of user 530, for example, between eyes of user 530 and scene 502.

Device 520 may include one or more scene-facing camera(s) 522. Scene-facing camera(s) 522 may be configured to be pointed toward scene 502 (e.g., away from user 530). For example, scene-facing camera(s) 522 may be pointed opposite display 526, such that as user 530 views display 526, scene-facing camera(s) 522 is pointed away from user 530 and toward scene 502. Scene-facing camera(s) 522 may capture images of scene 502 regularly, for example, at a frame rate (e.g., 30 or 60 frames per second (FPS)).

Device 520 may detect objects in images of scene 502. For example, device 520 may implement a trained object-detect model. Device 520 may use the trained object-detection model to identify objects in images of scene 502 captured by scene-facing camera(s) 522. For example, device 520 may detect each of object 504, object 506, object 508, text 510, QR code 512 phone number 514 and/or URL 516. In some aspects, device 520 may classify the objects (e.g., device 520 may determine classes to which the objects belong).

In some aspects, device 520 may detect objects according to a configurable list of objects object of interest (e.g., to user 530). For example, user 530 may edit a list of objects that may be of interest to user 530 including such things as: texts, texts in a target language, texts about a target topic, contact information, barcodes, barcodes for certain types of products, QR codes, items of food, products, a particular type of a thing (e.g., the user may be tasked with counting or inventorying

Device 520 may include one or more user-facing camera(s) 524. User-facing camera(s) 524 may be configured to be pointed toward user 530. For example, user-facing camera(s) 524 may be pointed in the same direction as display 526 and/or at an angle to view eyes of user 530 as user 530 views display 526. User-facing camera(s) 524 may capture images of user 530 regularly, for example, at a frame rate (e.g., 30 or 60 frames per second (FPS)).

In some aspects, scene-facing camera(s) 522 and/or user-facing camera(s) 524 may be configured to capture images whenever device 520 is powered on (including when device 520 is displaying information at display 526 and when display 526 is not displaying information and/or when display 526 is locked). Scene-facing camera(s) 522 and/or user-facing camera(s) 524 may be, or may include, what may be referred to as “always-on cameras” or “always-sensing cameras.” For example, anytime device 520 is active (or “on”), scene-facing camera(s) 522 and/or user-facing camera(s) 524 may be capturing images (e.g., at a frame-capture rate). In such aspects, camera(s) 522 and/or camera(s) 524 may be capturing images whether display 526 is displaying information or not. For example, display 526 may be turned off yet camera(s) 522 and/or camera(s) 524 may still be actively sensing. For instance, device 520 may use camera(s) 522 to detect QR codes or text codes. In the event that device 520 detects an object (e.g., an object from a list of interesting objects) in an image captured by camera(s) 522, device 520 may unlock (e.g., using camera(s) 524 and/or activate display 526 to display information.

In other aspects, scene-facing camera(s) 522 and/or user-facing camera(s) 524 may be activated by an application running at device 520. For example, one or more operations described herein (including scene-facing camera(s) 522 and/or user-facing camera(s) 524 capturing images) may be performed by device 520 responsive to an application running on device 520 initiating and/or controlling the operations.

In some aspects, display 526 may be, or may include, a see-through display. For example, user 530 may view scene 502 through display 526. In other aspects, display 526 may be, or may include, a pass-through display. For example, device 520 may capture images of scene 502 using scene-facing camera(s) 522 and display the captured images at display 526, such that user 530 views representations of scene 502 (including the objects therein) at display 526.

In either case, user-facing camera(s) 524 may capture images of eyes of user 530 and device 520 may determine gaze 532 of user 530 relative to scene 502. Further, device 520 may determine at which object in scene 502 user 530 is gazing. For example, in cases in which display 526 comprises a see-through display, user 530 may gaze through display 526 at object 504. User-facing camera(s) 524 may capture images of the eyes of user 530 and device 520 may determine where user 530 is gazing within scene 502. Additionally or alternatively, device 520 may determine at which object (e.g., of the detected objects) of scene 502 user 530 is gazing (e.g., based on relationship between the object in the scene and gaze 532).

As another example, in cases in which display 526 comprises a pass-through display, user 530 may gaze at a representation of an object as displayed at display 526. For example, display 526 may display live video data captured by scene-facing camera(s) 522. User-facing camera(s) 524 may capture images of the eyes of user 530 and device 520 may determine at which point of display 526 user 530 is gazing. Device 520 may determine where in scene 502 user 530 is gazing based on the representation of scene 502 displayed at display 526 and based on at which point of display 526 user 530 is gazing. Additionally or alternatively, device 520 may determine at which object (e.g., of the detected objects) of scene 502 user 530 is gazing at (e.g., based on where user 530 is gazing at display 526 and based on which objects are displayed at which point of display 526).

Having detected objects (e.g., based on images of scene 502) and having determined gaze 532 of user 530 (e.g., based on images of user 530), device 520 may determine an object of interest to user 530. For example, device 520 may determine an object of the detected objects at which user 530 is gazing. Device 520 may determine that the object at which user 530 is gazing is an object of interest to user 530.

Device 520 may determine to display information 528 at display 526 based on the object of interest. Determining to display information 528 at display 526 may include determining what information to display and determining a position of display 526 at which to information 528.

For example, if device 520 determines that user 530 is gazing at object 504, device 520 may determine to display information 528 related to object 504. For example, if object 504 is a tree, device 520 may determine to display information about the tree, for example, a species of the tree, a common name of the species of tree, and/or information regarding care of the tree.

As another example, if device 520 determines that user 530 is gazing at object 506, and object 506 is a landmark (e.g., a mountain range, a building, a statue, etc.), device 520 may determine to display information about the landmark. For example, device 520 may determine to display a name of the landmark, dates associated with the landmark, and/or text, images, and/or video conveying information about the significance of the landmark.

As yet another example, if device 520 determines that user 530 is gazing at text 510, device 520 may determine to translate text 510 from a first language into a second language. The first language and/or the second language may be based on user selections. For example, the user may be visiting a foreign country and may wish all text translated into a language of the user. As another example, the user may be learning a language and may wish to see text of the user's language translated into the language that the user is learning.

As yet another example, if device 520 determines that user 530 is gazing at QR code 512, device 520 may display information based on QR code 512. For example, if QR code 512 is associated with a URL, device 520 may display the URL.

As yet another example, if device 520 determines that user 530 is gazing at URL 516, device 520 may display information based on URL 516. For example, URL 516 may be associated with a website, device 520 may obtain information from the website (e.g., a descriptor or image of a landing page). Device 520 may display the information to user 530.

In some aspects, device 520 may include a memory and may store information in the memory. Device 520 may select information 528 to display from the stored information. Additionally or alternatively, device 520 may include a communication interface and may obtain information 528 from a remote source (e.g., a web server via a web search). For example, device 520 may perform an image-based search (e.g., based on an image of object 504 or object 506) to obtain information 528. As another example, device 520 may obtain information from a website (e.g., the website associated with the URL associated with QR code 512 and/or URL 516).

In some aspects, device 520 may display information 528 overlaid onto the object of interest in the field of view of user 530, for example, between the eyes of user 530 and the object of interest in scene 502. For example, if user 530 is gazing at text 510, device 520 may display translated text over text 510 in the field of view of user 530. As another example, if user 530 is gazing at object 504, device 520 may display an identifier of object 504 in a field of view of user 530 between the eyes of user 530 and object 504. Additionally or alternatively, device 520 may display information 528 proximate to what the object of interest in the field of view of user 530. In some aspects, device 520 may display information 528 overlaid onto a background of scene 502 (e.g., as determined using depth-detection techniques such as time-of-flight techniques, stereoscopic-imaging techniques, structured-light techniques, and/or monocular-depth detection techniques). In some aspects, device 520 may display information 528 overlaid onto a visually uniform portion of the scene (e.g., as determined by an analysis of an image of the scene). In some aspects, device 520 may display information 528 overlaid onto an uninteresting portion of the scene (e.g., as determined by tracking the gaze of the user over time).

Additionally or alternatively, device 520 may determine to cease displaying information 528, and/or to determine to not display information 528 based on gaze 532. For example, if user 530 is gazing at QR code 512 in scene 502, device 520 may determine to display information 528 based on determining gaze 532 is at QR code 512. User 530 may cease gazing at QR code 512; for example, user 530 may gaze at text 510 in scene 502. Device 520 may determine that user 530 is no longer gazing at QR code 512 and determine to cease displaying information 528 based on user 530 no longer gazing at QR code 512. Additionally or alternatively, device 520 may determine to display other information based on user 530 gazing at text 510.

In some aspects, device 520 may take actions based on the object of interest and/or based on information 528. In some aspects, device 520 may initiate the action further responsive to an instruction from user 530. In some cases, information 528 displayed at display 526 may be, or may include, a prompt for an instruction to take the action. For example, information 528 may include some information regarding the object of interest. If user 530 gazes at information 528 (e.g., for a number of seconds), device 520 may display additional information regarding the object of interest. As another example, information 528 may include information about a website. If device 520 determines that user 530 is gazing at the information, device 520 may open obtain additional information from the website and display the additional information.

In some aspects, device 520 may interpret a vocalization of the user, a hand gesture of the user, a head motion of the user, and/or an eye motion of the user as an instruction (e.g., relative to the taking a further action). For example, device 520 may include a microphone and may capture and/or interpret vocalizations of user 530 as instructions. Additionally or alternatively, scene-facing camera(s) 522 may capture images of hands of user 530 and device 520 may track the hands and interpret hand gestures as instructions. Additionally or alternatively, device 520 may include an inertial measurement unit (IMU) and may determine motion of the head of user 530 and interpret the motion as instructions. Additionally or alternatively, device 520 may determine head motion using a simultaneous localization and mapping (SLAM) technique based on images captured by scene-facing camera(s) 522. Additionally or alternatively, user-facing camera(s) 524 may capture images of eyes of user 530 and device 520 may track eye movements (including blinks and/or pointing of the eyes) and interpret the eye movements as instructions.

For example, device 520 may detect text 510 in scene 502. Further, device 520 may determine that gaze 532 is at text 510 and thus that text 510 is an object of interest to user 530. Responsive to determining that user 530 is interested in text 510, device 520 may display information 528 (e.g., a translation of text 510) overlaid onto text 510 in the field of view of user 530. Device 520 may detect a hand gesture of user 530 and interpret the hand gesture as an indication that user 530 wants additional information about text 510. Responsive to interpreting the hand gesture, device 520 may obtain and display additional information about text 510.

As another example, device 520 may detect QR code 512 in scene 502. Further device 520 may determine that gaze 532 is at QR code 512 and thus that QR code 512 is an object of interest to user 530. Responsive to determining that user 530 is interested in QR code 512, device 520 may display information 528 about a website associated with QR code 512. Device 520 may detect a vocalization of user 530 and interpret the vocalization as an indication that user 530 wants device 520 to open a browser to the website. Responsive to interpreting the vocalization, device 520 may open a browser to the website and display information from the website at display 526.

As yet another example, device 520 may detect phone number 514 in scene 502. Further, device 520 may determine that gaze 532 is at phone number 514 and thus that phone number 514 is an object of interest to user 530. Responsive to determining that user 530 is interested in phone number 514, device 520 may display a prompt querying user 530 regarding whether user 530 wants to save phone number 514 as a contact, text phone number 514, or call phone number 514. Device 520 may detect an eye motion of user 530 (e.g., gazing at a portion of the prompt). Device 520 may interpret the eye motion as an indication that user 530 wants to text phone number 514. Responsive to interpreting the eye motion, device 520 may generate a blank text message to phone number 514.

In some aspects, device 520 may initiate one or more of the operations described herein responsive to an instruction from user 530. For example, initially, display 526 may not be displaying information 528. In cases in which display 526 is a see-through display, display 526 may display no information 528 and in cases in which display 526 is a pass-through display, display 526 may display only the images/video captured by scene-facing camera(s) 522 without any additional information 528. User 530 may point scene-facing camera(s) 522 at an object of interest (e.g., text 510) and provide an instruction (e.g., using a wakeword). For example, user 530 may say “wakeword, translate.” Device 520 may use user-facing camera(s) 524 to capture an image of user 530 (e.g., for facial-recognition authentication). Device 520 may use scene-facing camera(s) 522 to capture an image of text 510. Then, device 520 may translate text 510 according to the instruction.

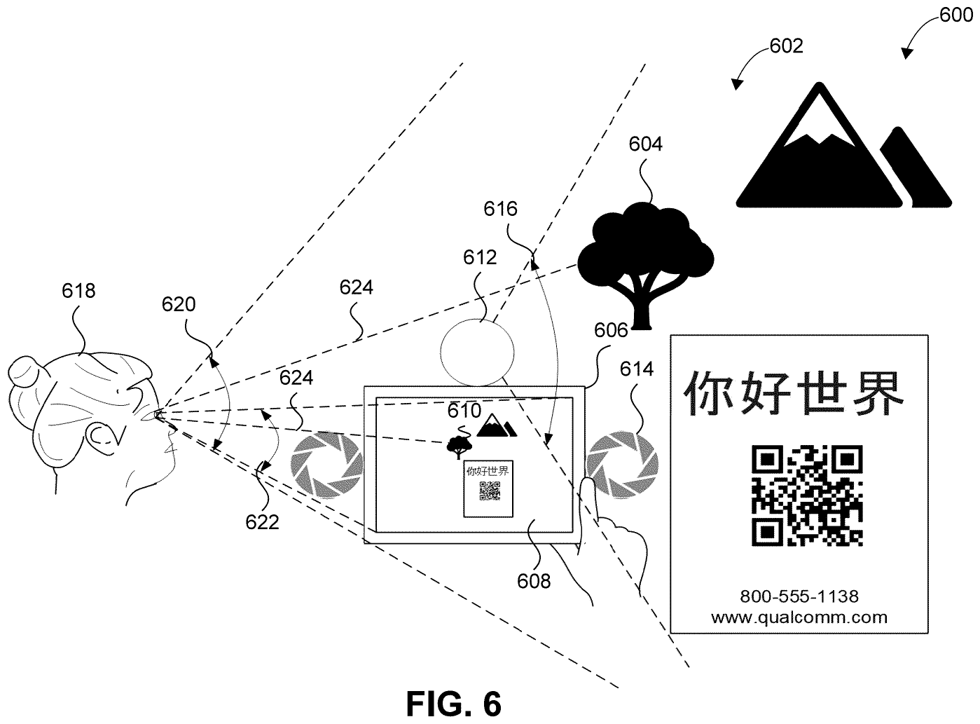

FIG. 6 is a diagram illustrating an example environment 600 in which an example device 606 may display information based on a gaze of a user 618, according to various aspects of the present disclosure. In general, device 606 may use one or more scene-facing camera(s) 612 to capture images of scene 602. Device 606 may detect objects in the images of scene 602 (e.g., object 604). Further, device 606 may use one or more user-facing camera(s) 614 to capture images of eyes of user 618. Device 606 may track gaze 624 of user 618. Device 606 may determine an object of interest to user 618 based on gaze 624 of user 618. Device 606 may then determine information to display at display 608 based on the object of interest. Device 606 May be an example of device 520 of FIG. 5. Device 606 may be a handheld device, for example, device 606 may be an example of handheld device 302 of FIG. 3.

Device 606 may be within a field of view 620 of user 618. Device 606 may occupy portion 622 of field of view 620 of user 618, for example, device 606 may be between user 618 and scene 602 and block portion 622 of field of view 620 of user 618 of scene 602.

Scene-facing camera 612 may have field of view 616 of scene 602. Device 606 may display images at display 608 based on the images captured by scene-facing camera 612. For example, device 606 may display images of field of view 616 as captured by scene-facing camera 612.

Field of view 616 of scene-facing camera 612 (and/or the images displayed at display 608) may differ from portion 622 of field of view 620. Some XR devices may seek to replicate portion 622 of field of view 620 with images displayed at display 608. However, device 606 may display images at display 608 that do not seek to replicate portion 622 of field of view 620, for example, by displaying a wider field of view than portion 622. Additionally or alternatively, scene-facing camera 612 may be pointed in a different direction than field of view 620 of user 618. Additionally or alternatively, a line of sight (e.g., as illustrated by gaze 624) between user 618 (e.g., between an eye of user 618) and representation 610 may be different than a line of sight (e.g., as illustrated by gaze 626) between user 618 (e.g., between an eye of user 618) and object 604 in scene 602.

Device 606 may detect and/or track a gaze 624 of user 618. Device 606 may determine that user 618 is gazing at a representation 610 of object 604 as displayed at display 608. Device 606 may determine that user 618 is interested in object 604 based on user 618 gazing at representation 610. Device 606 may determine information to display at display 608 based on determining that user 618 is interested in object 604 and/or based on determining that user 618 is gazing at representation 610 of object 604 as displayed at display 608. After determining to display information based on object 604, device 606 may perform any and/or all of the operations described above with regard to device 520.

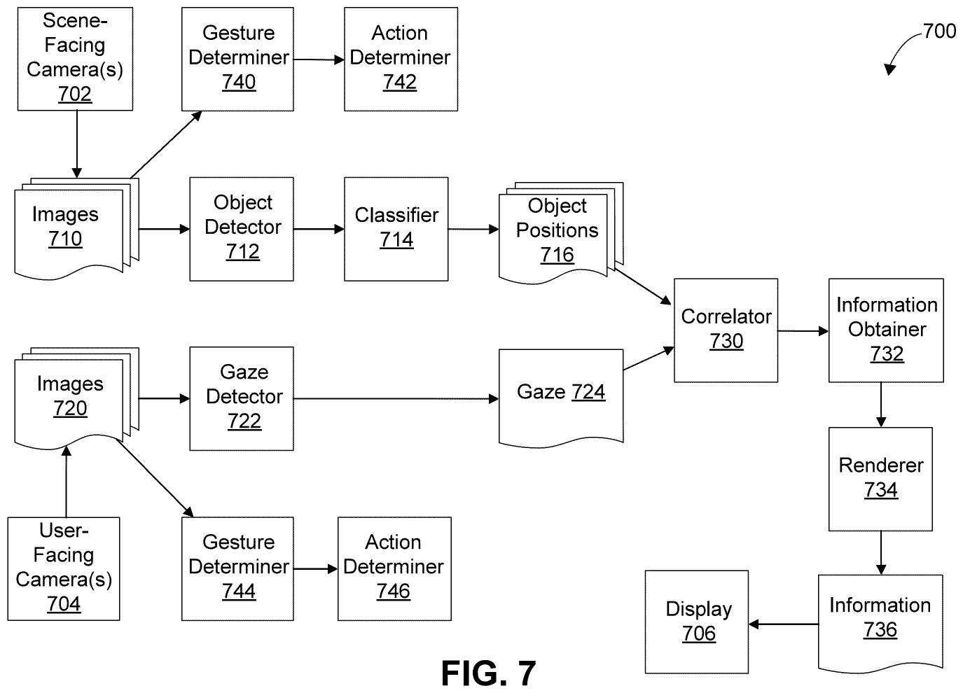

FIG. 7 is a block diagram illustrating an example device 700 for displaying information based on a user's gaze, according to various aspects of the present disclosure. Device 700 includes scene-facing camera(s) 702, a user-facing camera(s) 704, and a display 706. Scene-facing camera(s) 702 may be the same as, may be substantially similar to, and/or may perform the same, or substantially the same, operations as scene-facing camera(s) 522 of FIG. 5 and/or scene-facing camera(s) 612 of FIG. 6. User-facing camera(s) 704 may be the same as, may be substantially similar to, and/or may perform the same, or substantially the same, operations as user-facing camera(s) 524 of FIG. 5 and/or user-facing camera(s) 614 of FIG. 6. Display 706 may be the same as, may be substantially similar to, and/or may perform the same, or substantially the same, operations as display 526 of FIG. 5 and/or display 608 of FIG. 6. Device 700 may additionally include one or more processors that may execute the operation associated with object detector 712, classifier 714, gaze detector 722, correlator 730, information obtainer 732, renderer 734, gesture determiner 740, action determiner 742, gesture determiner 744, and action determiner 746, each of which may be implemented in software and/or as one or more machine-learning models.

Device 700 may obtain images 710 (e.g., from scene-facing camera(s) 702). Images 710 may be images of a scene (e.g., images of scene 502 as captured by scene-facing camera(s) 522 of FIG. 5 and/or scene-facing camera(s) 612 of FIG. 6).

Object detector 712 may detect objects in images 710. Object detector 712 may be, or may include, a convolutional neural network (CNN) or one or more vision transformers (e.g., with detection arch), such as, for example, a single-shot detector (SSD), you only look once (YOLO), or Faster region-convolutional neural network (Faster RCNN). In some aspects, object detector 712 may be trained (e.g., through a back propagation training process) to detect objects in images.

In some aspects, object detector 712 may output object positions 716, which may be, or may include, image coordinates (e.g., bounding boxes) describing pixels of images 710 that represent objects. Additionally or alternatively, object positions 716 may be, or may include, spatial coordinates (e.g., relative to scene-facing camera(s) 702 or relative to a reference coordinate system).

In some aspects, device 700 may include a classifier 714 that may classify the objects detected by object detector 712. For example, classifier 714 may assign a label to detected objects labelling the objects as people, animals, vehicles, text, landmarks, etc. In some aspects, classifier 714 may be trained (e.g., through a supervised and/or unsupervised training process) to determine classes of objects. In some aspects, classifier 714 may be included in object detector 712. In other aspects, classifier 714 may be omitted from device 700.

Gaze detector 722 may determine gaze 724 based on images 720 of eyes of a user (e.g., captured by user-facing camera(s) 704). Gaze detector 722 may be, or may include, a CNN classifier. Output heads for such a CNN may be, or may include, (gaze angles, eye visibility etc.). In some aspects, gaze detector 722 may be trained (e.g., through a back propagation training process) to determine a gaze of a user based on images of the eyes of the user.

Gaze 724 may be, or may include, an indication of a gaze of a user. In some aspects, gaze 724 may be expressed in terms of angles (e.g., relative to a gaze directly ahead). For example, gaze 724 may be expressed in terms of a azimuth and elevation angle (or pitch and yaw). Additionally or alternatively, gaze 724 may be relative to image coordinates. For example, gaze 724 may relate to coordinates of a display (e.g., display 706 through which a scene is being viewed either in a see-through configuration or a pass-through configuration). Additionally or alternatively, gaze 724 may be relative to the scene (e.g., through a relative or reference coordinate system).

Correlator 730 may correlate gaze 724 with objects (e.g., described by object positions 716). In some aspects, correlator 730 may compare object positions 716 with gaze 724 and determine an object at which gaze 724 is directed. For example, in cases in which object positions 716 and gaze 724 are both relative to image coordinates of display 706, correlator 730 may correlate the object with gaze 724 based on a correspondence of the image coordinates. As another example, in cases in which object positions 716 and gaze 724 are both relative to a relative or reference coordinate system, correlator 730 may model the scene including objects in the scene and gaze 724 within the scene. In some aspects, correlator 730 may be, or may include, a machine-learning model trained to correlate objects with gazes. In some aspects, correlator 730 may determine an object of interest to a user of device 700.

Responsive to determining an object of interest to a user of device 700, information obtainer 732 may obtain information based on the object. In some aspects, information obtainer 732 may obtain the information from a local memory (e.g., included in or coupled to device 700). Additionally or alternatively, information obtainer 732 may obtain the information from a remote device (e.g., a server) via a communicative connection (e.g., via communication network, such as the internet).

Renderer 734 may render information 736 to be displayed at display 706. For example, renderer 734 determine where and/or how to display information 736 at display 706.

In some aspects, device 700 may include a gesture determiner 740 and/or a gesture determiner 744 that may detect gestures. For example, gesture determiner 740 may track hands of a user in images 710 and interpret a gesture based on movement of the hands. As another example, gesture determiner 744 may track eyes of the user in images 720 and interpret a gesture based on eye movements. In some aspects, gesture determiner 740 may be, or may include, a machine-learning model trained to interpret gestures based on images of hands. In some aspects, gesture determiner 744 may be, or may include, a machine-learning model trained to interpret gestures based on images of eyes. In some aspects, one or both of gesture determiner 740 and gesture determiner 744 may be omitted.

In some aspects, device 700 may include action determiner 742 and/or action determiner 746 that may determine an action based on gestures interpreted by gesture determiner 740 and/or gesture determiner 744 respectively. For example, action determiner 742 may take an action responsive to a gesture (e.g., a hand gesture) determined by gesture determiner 740. For instance, object detector 712 may detect a phone number in images 710. Correlator 730 may determine that gaze 724 is at the phone number. Information obtainer 732 may cause renderer 734 and display 706 to display information 736 including a query regarding calling the phone number. Action determiner 742 may initiate a phone call to the phone number responsive to gesture determiner 740 interpreting a hand gesture as an indication that the user wishes to call the phone number.

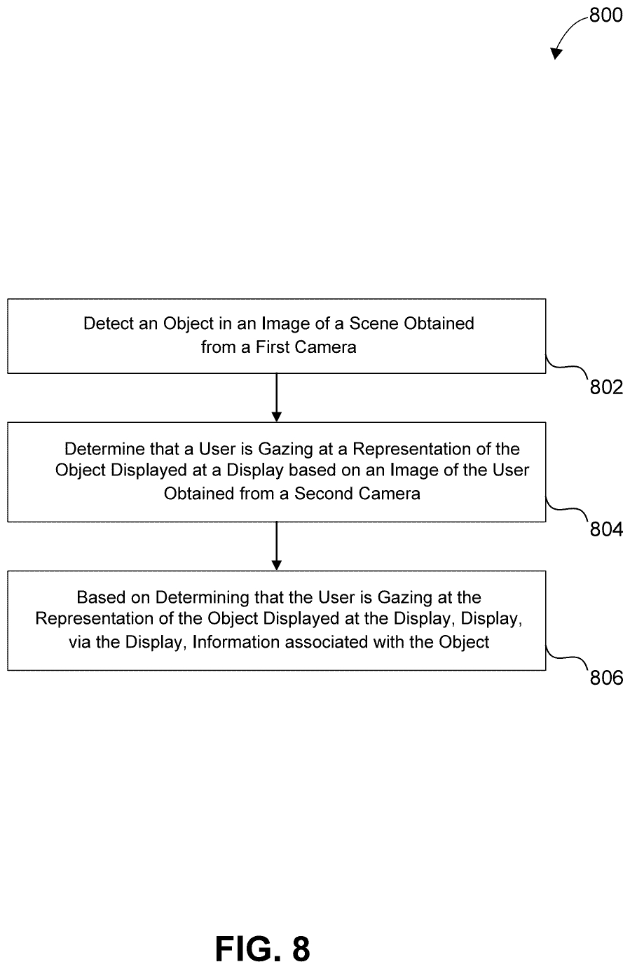

FIG. 8 is a flow diagram illustrating a process 800 for displaying information based on a user's gaze, in accordance with aspects of the present disclosure. One or more operations of process 800 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 800. The one or more operations of process 800 may be implemented as software components that are executed and run on one or more processors.

At block 802, a computing device (or one or more components thereof) may detect an object in an image of a scene obtained from a first camera. For example, device 606 of FIG. 6 may object 604 in an image of scene 602 captured by scene-facing camera 612.

In some aspects, the first camera may be, or may include, a scene-facing camera. In some aspects, the scene-facing camera may be configured to capture images by default when the device is active. For example, the scene-facing camera may be, or may include, an “always-on camera” or an “always-sensing camera.” In some aspects, the computing device (or one or more components thereof) may be configured to initiate, on the device, an application that activates the scene-facing camera. For example, the scene-facing camera may not be “always on” but may be activated by an application.

In some aspects, the computing device (or one or more components thereof) may be configured to detect a plurality of objects in the scene based on images of the scene. For example, device 606 may detect object 604, and other objects in scene 602. In some aspects, the object may be detected based on a list of interesting objects. For example, object 604 may be selected from among all objects detected based on a list of interesting objects. In some aspects, the list of interesting objects may include: text; contact information; a barcode; a quick response (QR) code; and an item of food. For example, object 604 may be selected from a number of objects detected by device 606 based on object 604 being a tree, which is on the list of interesting objects. In some aspects, an object of interest may be text. The text may be in a target language. For example, the text in the list of interesting objects is text in a target language. For example, text 510 of FIG. 5 may be detected based on text 510 being in a target language. In some aspects, the list of interesting objects may be user configurable. For example, user 530 may be able to configure the list of interesting objects.

At block 804, the computing device (or one or more components thereof) may determine that a user is gazing at a representation of the object displayed at a display based on an image of the user obtained from a second camera. For example, device 606 may detect gaze 624 of user 618 based on an image of user 618 captured by user-facing camera(s) 614. Device 606 may further determine that user 618 is gazing at representation 610 of object 604 as displayed at display 608

In some aspects, the second camera may be, or may include, a user-facing camera. In some aspects, the second camera may capture an image of eyes of the user. In some aspects, the user-facing camera may be configured to capture images by default when the device is active. For example, the user-facing camera may be, or may include, an “always-on camera” or an “always-sensing camera.” In some aspects, the computing device (or one or more components thereof) may be configured to initiate, on the device, an application that activates the user-facing camera. In some aspects, the computing device (or one or more components thereof) may be configured to initiate an application that activates at least one of the first camera or the second camera. For example, the user-facing camera may not be “always on” but may be activated by an application.

At block 806, the computing device (or one or more components thereof) may, based on determining that the user is gazing at the representation of the object displayed at the display, display, via the display, information associated with the object. For example, based on device 606 determining that user 618 is gazing at representation 610 of object 604 as displayed on display 608, device 606 may determine to display information associate with object 604 at display 608.

In some aspects, the computing device (or one or more components thereof) may determine that the object is the object of interest of the user by determining, based on the gaze, that the user is gazing at a representation of the object displayed at the display. For example, device 520 may determine that QR code 512 is of interest to user 530 by determining that gaze 532 is at a representation of QR code 512 displayed at display 526. In some aspects, the display may be, or may include, a pass-through display configured to be positioned in a field of view of the user between the user and the scene. For example, display 526 may be a pass-through display. In some aspects, the pass-through display may be part of an XR system and/or a handheld device. As another example, device 606 may determine that object 604 is of interest to user 618 by determining that gaze 624 is at representation 610 of object 604 displayed at display 608. In some aspects, the display may be, or may include, a handheld display configured to be positioned in a field of view of the user between the user and the scene. For example, display 608 may be positioned within field of view 620 of user 618 between user 618 and scene 602.

In some aspects, the computing device (or one or more components thereof) may include the first camera, the second camera, and the display. For example, device 606 may include scene-facing camera 612, user-facing camera 614, and display 608. In some aspects, the first camera is configured to capture a field of view of the scene; the display fills a portion of a field of view of the user; and the field of view of the scene is not the same as the portion of the field of view of the user. For example, display 608 may occupy portion 622 of field of view 620 of user 618. However, portion 622 of field of view 620 may be a not the same as the entirety of field of view 620 of user 618. In some aspects, a line of sight between the user and the object (e.g., as illustrated by gaze 626) may be different than a line of sight between the user and the representation of the object displayed by the display (e.g., as illustrated by gaze 624). For example, a line of sight (e.g., a direct line) between an eye of user 618 and object 604 may be different that a line of sight between an eye of user 618 and representation 610 of object 604 at display 608.

In some aspects, the computing device (or one or more components thereof) may be configured to initiate an action responsive to determining that the object is the object of interest of the user or determining that the user is gazing at the representation of the object as displayed at the display. In some aspects, the action may be based on the object. The action may be, or may include, translating text, wherein the object comprises the text; preparing a communication, wherein the object comprises contact information and the communication is based on the contact information; requesting data from a server, wherein the object comprises a barcode or a quick-response (QR) code and the requested data is based on the barcode or the QR code; identifying the object; and/or logging the object. For example, device 520 may be configured to translate text 510, prepare a phone call or text message to phone number 514, request data associated with phone number 514 and/or URL 516 from a server, identify object 504 and/or object 506, and/or log an object.

In some aspects, the action may be initiated further responsive to an instruction from the use. In some aspects, the information displayed at the display may be, or may include, a prompt relative to the instruction.

In some aspects, the computing device (or one or more components thereof) may be configured to interpret, as the instruction, at least one of: a vocalization of the user; a hand gesture of the user; a head motion of the user; or an eye motion of the user. For example, device 520 may include a microphone and may capture and interpret a vocalization of device 520 as the instruction. As another example, scene-facing camera(s) 522 may capture an image of hands of user 530 and interpret a hand gesture of the hands as the instruction. As yet another example, device 520 may include an inertial measurement unit (IMU) and may detect a head motion and interpret the head motion as the instruction. As yet another example, device 520 may use a simultaneous localization and mapping (SLAM) technique with images captured by scene-facing camera(s) 522 to detect a head motion and interpret the head motion as the instruction. As yet another example, device 520 may detect an eye motion based on images captured by user-facing camera(s) 524 and interpret the eye motion as the instruction.

In some examples, as noted previously, the methods described herein (e.g., process 800 of FIG. 8, and/or other methods described herein) can be performed, in whole or in part, by a computing device or apparatus. In one example, one or more of the methods can be performed by XR system 100 and/or XR device 102 of FIG. 1, XR system 200 and/or XR device 202 and companion device 204 of FIG. 2, XR system 300 and/or handheld device 302 of FIG. 3, XR system 400 of FIG. 4, device 520 of FIG. 5, device 606 of FIG. 6, or by another system or device. In another example, one or more of the methods (e.g., process 800 of FIG. 8, and/or other methods described herein) can be performed, in whole or in part, by the computing-device architecture 1100 shown in FIG. 11. For instance, a computing device with the computing-device architecture 1100 shown in FIG. 11 can include, or be included in, the components of the XR system 100, XR device 102, XR system 200, XR device 202, companion device 204, XR system 300, handheld device 302, XR system 400, device 520, and/or device 606 and can implement the operations of process 800, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 800, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 800, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

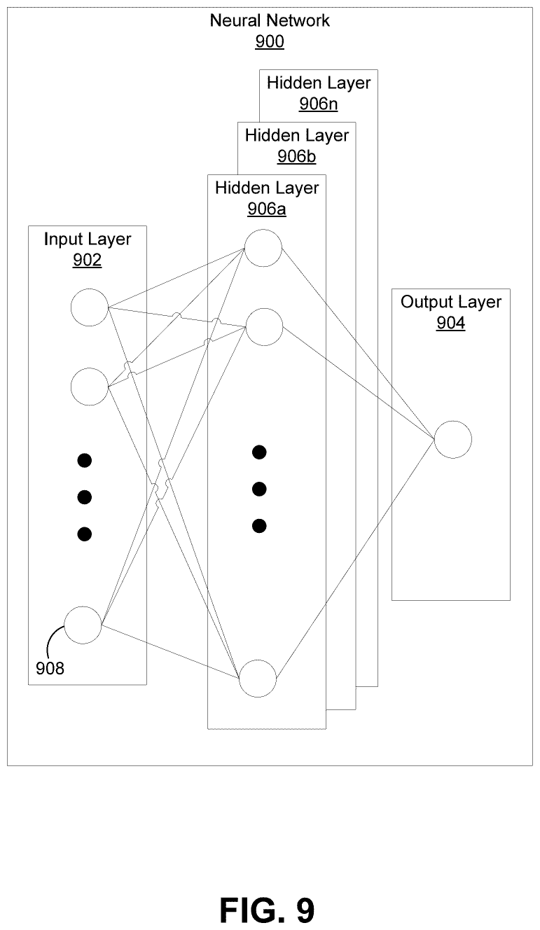

FIG. 9 is an illustrative example of a neural network 900 (e.g., a deep-learning neural network) that can be used to implement machine-learning based object detection, object classification, gaze detection, image recognition (e.g., face recognition, object recognition, scene recognition, etc.), feature extraction, gaze detection, gaze prediction, feature segmentation, implicit-neural-representation generation, rendering, classification, authentication, and/or automation.

An input layer 902 includes input data. In one illustrative example, input layer 902 can include data representing images from scene-facing camera(s) 522 and/or user-facing camera(s) 524. Neural network 900 includes multiple hidden layers hidden layers 906a, 906b, through 906n. The hidden layers 906a, 906b, through hidden layer 906n include “n” number of hidden layers, where “n” is an integer greater than or equal to one. The number of hidden layers can be made to include as many layers as needed for the given application. Neural network 900 further includes an output layer 904 that provides an output resulting from the processing performed by the hidden layers 906a, 906b, through 906n. In one illustrative example, output layer 904 can provide object detections, object classifications, gaze detections, and/or gaze predictions.

Neural network 900 may be, or may include, a multi-layer neural network of interconnected nodes. Each node can represent a piece of information. Information associated with the nodes is shared among the different layers and each layer retains information as information is processed. In some cases, neural network 900 can include a feed-forward network, in which case there are no feedback connections where outputs of the network are fed back into itself. In some cases, neural network 900 can include a recurrent neural network, which can have loops that allow information to be carried across nodes while reading in input.

Information can be exchanged between nodes through node-to-node interconnections between the various layers. Nodes of input layer 902 can activate a set of nodes in the first hidden layer 906a. For example, as shown, each of the input nodes of input layer 902 is connected to each of the nodes of the first hidden layer 906a. The nodes of first hidden layer 906a can transform the information of each input node by applying activation functions to the input node information. The information derived from the transformation can then be passed to and can activate the nodes of the next hidden layer 906b, which can perform their own designated functions. Example functions include convolutional, up-sampling, data transformation, and/or any other suitable functions. The output of the hidden layer 906b can then activate nodes of the next hidden layer, and so on. The output of the last hidden layer 906n can activate one or more nodes of the output layer 904, at which an output is provided. In some cases, while nodes (e.g., node 908) in neural network 900 are shown as having multiple output lines, a node has a single output and all lines shown as being output from a node represent the same output value.

In some cases, each node or interconnection between nodes can have a weight that is a set of parameters derived from the training of neural network 900. Once neural network 900 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 900 to be adaptive to inputs and able to learn as more and more data is processed.

Neural network 900 may be pre-trained to process the features from the data in the input layer 902 using the different hidden layers 906a, 906b, through 906n in order to provide the output through the output layer 904. In an example in which neural network 900 is used to identify features in images, neural network 900 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 900 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until neural network 900 is trained well enough so that the weights of the layers are accurately tuned.

For the example of identifying objects in images, the forward pass can include passing a training image through neural network 900. The weights are initially randomized before neural network 900 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 900, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 900 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½(target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 900 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the dl where opposite direction of the gradient. The weight update can be denoted as w=wᵢ−ηdL/dW, where w denotes a weight, wᵢ denotes the initial weight, and n denotes a learning rate. The learning rate can be set to any suitable value, with a high learning rate including larger weight updates and a lower value indicating smaller weight updates.

Neural network 900 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 900 can include any other deep network other than a CNN, such as an autoencoder, a deep belief nets (DBNs), a Recurrent Neural Networks (RNNs), among others.

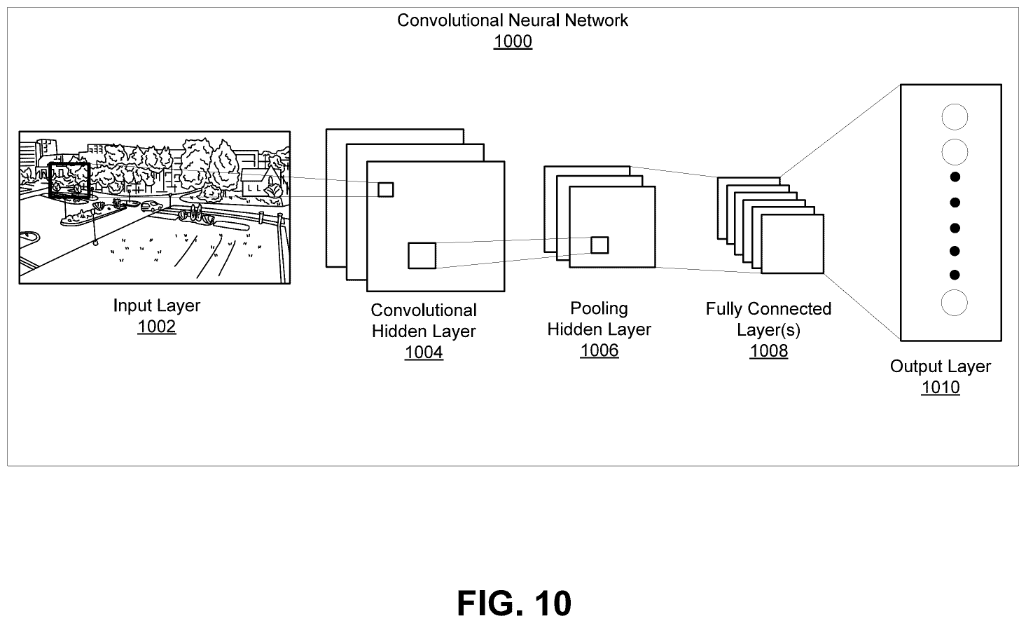

FIG. 10 is an illustrative example of a convolutional neural network (CNN) 1000. The input layer 1002 of the CNN 1000 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1004, an optional non-linear activation layer, a pooling hidden layer 1006, and fully connected layer 1008 (which fully connected layer 1008 can be hidden) to get an output at the output layer 1010. While only one of each hidden layer is shown in FIG. 10, one of ordinary skill will appreciate that multiple convolutional hidden layers, non-linear layers, pooling hidden layers, and/or fully connected layers can be included in the CNN 1000. As previously described, the output can indicate a single class of an object or can include a probability of classes that best describe the object in the image.

The first layer of the CNN 1000 can be the convolutional hidden layer 1004. The convolutional hidden layer 1004 can analyze image data of the input layer 1002. Each node of the convolutional hidden layer 1004 is connected to a region of nodes (pixels) of the input image called a receptive field. The convolutional hidden layer 1004 can be considered as one or more filters (each filter corresponding to a different activation or feature map), with each convolutional iteration of a filter being a node or neuron of the convolutional hidden layer 1004. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1004. Each connection between a node and a receptive field for that node learns a weight and, in some cases, an overall bias such that each node learns to analyze its particular local receptive field in the input image. Each node of the convolutional hidden layer 1004 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1004 is due to each node of the convolutional layer being applied to its corresponding receptive field. For example, a filter of the convolutional hidden layer 1004 can begin in the top-left corner of the input image array and can convolve around the input image. As noted above, each convolutional iteration of the filter can be considered a node or neuron of the convolutional hidden layer 1004. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1004. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1004.

The mapping from the input layer to the convolutional hidden layer 1004 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1004 can include several activation maps in order to identify multiple features in an image. The example shown in FIG. 10 includes three activation maps. Using three activation maps, the convolutional hidden layer 1004 can detect three different kinds of features, with each feature being detectable across the entire image.

In some examples, a non-linear hidden layer can be applied after the convolutional hidden layer 1004. The non-linear layer can be used to introduce non-linearity to a system that has been computing linear operations. One illustrative example of a non-linear layer is a rectified linear unit (ReLU) layer. A ReLU layer can apply the function f(x)=max (0, x) to all of the values in the input volume, which changes all the negative activations to 0. The ReLU can thus increase the non-linear properties of the CNN 1000 without affecting the receptive fields of the convolutional hidden layer 1004.

The pooling hidden layer 1006 can be applied after the convolutional hidden layer 1004 (and after the non-linear hidden layer when used). The pooling hidden layer 1006 is used to simplify the information in the output from the convolutional hidden layer 1004. For example, the pooling hidden layer 1006 can take each activation map output from the convolutional hidden layer 1004 and generates a condensed activation map (or feature map) using a pooling function. Max-pooling is one example of a function performed by a pooling hidden layer. Other forms of pooling functions be used by the pooling hidden layer 1006, such as average pooling, L2-norm pooling, or other suitable pooling functions. A pooling function (e.g., a max-pooling filter, an L2-norm filter, or other suitable pooling filter) is applied to each activation map included in the convolutional hidden layer 1004. In the example shown in FIG. 10, three pooling filters are used for the three activation maps in the convolutional hidden layer 1004.

In some examples, max-pooling can be used by applying a max-pooling filter (e.g., having a size of 2×2) with a stride (e.g., equal to a dimension of the filter, such as a stride of 2) to an activation map output from the convolutional hidden layer 1004. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1004 having a dimension of 24×24 nodes, the output from the pooling hidden layer 1006 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1000.

The final layer of connections in the network is a fully-connected layer that connects every node from the pooling hidden layer 1006 to every one of the output nodes in the output layer 1010. Using the example above, the input layer includes 28×28 nodes encoding the pixel intensities of the input image, the convolutional hidden layer 1004 includes 3×24×24 hidden feature nodes based on application of a 5×5 local receptive field (for the filters) to three activation maps, and the pooling hidden layer 1006 includes a layer of 3×12×12 hidden feature nodes based on application of max-pooling filter to 2×2 regions across each of the three feature maps. Extending this example, the output layer 1010 can include ten output nodes. In such an example, every node of the 3×12×12 pooling hidden layer 1006 is connected to every node of the output layer 1010.

The fully connected layer 1008 can obtain the output of the previous pooling hidden layer 1006 (which should represent the activation maps of high-level features) and determines the features that most correlate to a particular class. For example, the fully connected layer 1008 can determine the high-level features that most strongly correlate to a particular class and can include weights (nodes) for the high-level features. A product can be computed between the weights of the fully connected layer 1008 and the pooling hidden layer 1006 to obtain probabilities for the different classes. For example, if the CNN 1000 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1010 can include an M-dimensional vector (in the prior example, M=10). M indicates the number of classes that the CNN 1000 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 11 illustrates an example computing-device architecture 1100 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1100 may include, implement, or be included in any or all of XR system 100 and/or XR device 102 of FIG. 1, XR system 200 and/or XR device 202 and companion device 204 of FIG. 2, XR system 300 and/or handheld device 302 of FIG. 3, XR system 400 of FIG. 4, device 520 of FIG. 5, and/or device 606 of FIG. 6. Additionally or alternatively, computing-device architecture 1100 may be configured to perform process 800, and/or other process described herein.

The components of computing-device architecture 1100 are shown in electrical communication with each other using connection 1112, such as a bus. The example computing-device architecture 1100 includes a processing unit (CPU or processor) 1102 and computing device connection 1112 that couples various computing device components including computing device memory 1110, such as read only memory (ROM) 1108 and random-access memory (RAM) 1106, to processor 1102.

Computing-device architecture 1100 can include a cache of high-speed memory connected directly with, in close proximity to, or integrated as part of processor 1102. Computing-device architecture 1100 can copy data from memory 1110 and/or the storage device 1114 to cache 1104 for quick access by processor 1102. In this way, the cache can provide a performance boost that avoids processor 1102 delays while waiting for data. These and other modules can control or be configured to control processor 1102 to perform various actions. Other computing device memory 1110 may be available for use as well. Memory 1110 can include multiple different types of memory with different performance characteristics. Processor 1102 can include any general-purpose processor and a hardware or software service, such as service 1 1116, service 2 1118, and service 3 1120 stored in storage device 1114, configured to control processor 1102 as well as a special-purpose processor where software instructions are incorporated into the processor design. Processor 1102 may be a self-contained system, containing multiple cores or processors, a bus, memory controller, cache, etc. A multi-core processor may be symmetric or asymmetric.

To enable user interaction with the computing-device architecture 1100, input device 1122 can represent any number of input mechanisms, such as a microphone for speech, a touch-sensitive screen for gesture or graphical input, keyboard, mouse, motion input, speech and so forth. Output device 1124 can also be one or more of a number of output mechanisms known to those of skill in the art, such as a display, projector, television, speaker device, etc. In some instances, multimodal computing devices can enable a user to provide multiple types of input to communicate with computing-device architecture 1100. Communication interface 1126 can generally govern and manage the user input and computing device output. There is no restriction on operating on any particular hardware arrangement and therefore the basic features here may easily be substituted for improved hardware or firmware arrangements as they are developed.

Storage device 1114 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1106, read only memory (ROM) 1108, and hybrids thereof. Storage device 1114 can include services 1116, 1118, and 1120 for controlling processor 1102. Other hardware or software modules are contemplated. Storage device 1114 can be connected to the computing device connection 1112. In one aspect, a hardware module that performs a particular function can include the software component stored in a computer-readable medium in connection with the necessary hardware components, such as processor 1102, connection 1112, output device 1124, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. A device for displaying information, the device comprising: a first camera; a second camera; a display; at least one memory; and at least one processor coupled to the at least one memory and configured to: detect an object in an image of a scene obtained from the first camera; detect a gaze of a user relative to the scene based on an image of the user obtained from the second camera; determine that the object is an object of interest of the user based on a relationship between the gaze of the user and the object; and based on determining that the object is the object of interest of the user, display, via the display, information associated with the object.
Aspect 2. The device of aspect 1, wherein the first camera comprises a scene-facing camera.
Aspect 3. The device of aspect 2, wherein the scene-facing camera is configured to capture images by default when the device is active.
Aspect 4. The device of aspect 2, wherein the at least one processor is further configured to initiate an application that activates the scene-facing camera.
Aspect 5. The device of any one of aspects 1 to 4, wherein the second camera comprises a user-facing camera.
Aspect 6. The device of aspect 5, wherein the user-facing camera is configured to capture images by default when the device is active.
Aspect 7. The device of aspect 5, wherein the at least one processor is further configured to initiate an application that activates the user-facing camera.
Aspect 8. The device of any one of aspects 1, 2, or 5, wherein the at least one processor is further configured to initiate an application that activates at least one of the first camera or the second camera.
Aspect 9. The device of any one of aspects 1 to 8, wherein to determine that the object is the object of interest of the user the at least one processor is configured to determine, based on the gaze, that the user is gazing at the object in the scene through the display.
Aspect 10. The device of aspect 9, wherein the display comprises a see-through display configured to be positioned in a field of view of the user between the user and the scene.
Aspect 11. The device of aspect 10, wherein the see-through display is part of an extended reality (XR) system.
Aspect 12. The device of any one of aspects 1 to 8, wherein to determine that the object is the object of interest of the user the at least one processor is configured to determine, based on the gaze, that the user is gazing at a representation of the object displayed at the display.
Aspect 13. The device of aspect 12, wherein the display comprises a pass-through display configured to be positioned in a field of view of the user between the user and the scene.
Aspect 14. The device of aspect 13, wherein the pass-through display is part of at least one of: an extended reality (XR) system; or a handheld device.
Aspect 15. The device of any one of aspects 1 to 8, wherein to determine that the object is the object of interest of the user the at least one processor is configured to determine, based on the gaze, that the user is gazing at the object in the scene.
Aspect 16. The device of any one of aspects 1 to 15, wherein the at least one processor is further configured to initiate an action responsive to determining that the object is the object of interest of the user.
Aspect 17. The device of aspect 16, wherein the action is based on the object.
Aspect 18. The device of aspect 17, wherein the action is at least one of: translating text, wherein the object comprises the text; preparing a communication, wherein the object comprises contact information and the communication is based on the contact information; requesting data from a server, wherein the object comprises a barcode or a quick-response (QR) code and the requested data is based on the barcode or the QR code; identifying the object; or logging the object.
Aspect 19. The device of any one of aspects 16 to 18, wherein the action is initiated further responsive to an instruction from the user.
Aspect 20. The device of aspect 19, wherein the information displayed at the display comprises a prompt relative to the instruction.
Aspect 21. The device of aspect 20, further comprising interpreting, as the instruction, at least one of: a vocalization of the user; a hand gesture of the user; a head motion of the user; or an eye motion of the user.
Aspect 22. The device of any one of aspects 1 to 21, wherein the at least one processor is further configured to detect a plurality of objects in the scene based on images of the scene.
Aspect 23. The device of any one of aspects 1 to 22, wherein the object is detected based on a list of interesting objects.
Aspect 24. The device of aspect 23, wherein the list of interesting objects comprises: text; contact information; a barcode; a quick response (QR) code; and an item of food.
Aspect 25. A method for displaying information, the method comprising: detecting an object in an image of a scene obtained from a first camera of a device; detecting a gaze of a user relative to the scene based on an image of the user obtained from a second camera of the device; determining that the object is an object of interest of the user based on a relationship between the gaze of the user and the object; and based on determining that the object is the object of interest of the user, displaying, via a display of the device, information associated with the object.
Aspect 26. The method of aspect 25, wherein the first camera comprises a scene-facing camera.
Aspect 27. The method of aspect 26, wherein the scene-facing camera is configured to capture images by default when the device is active.
Aspect 28. The method of aspect 26, further comprising initiating, on the device, an application that activates the scene-facing camera.
Aspect 29. The method of any one of aspects 25 to 28, wherein the second camera comprises a user-facing camera.
Aspect 30. The method of aspect 29, wherein the user-facing camera is configured to capture images by default when the device is active.
Aspect 31. The method of aspect 29, further comprising initiating, on the device, an application that activates the user-facing camera.
Aspect 32. The method of any one of aspects 25, 26, or 29, further comprising initiating an application that activates at least one of the first camera or the second camera.
Aspect 33. The method of any one of aspects 25 to 32, wherein determining that the object is the object of interest of the user comprises determining, based on the gaze, that the user is gazing at the object in the scene through the display.
Aspect 34. The method of aspect 33, wherein the display comprises a see-through display configured to be positioned in a field of view of the user between the user and the scene.
Aspect 35. The method of aspect 34, wherein the see-through display is part of an extended reality (XR) system.
Aspect 36. The method of any one of aspects 25 to 32, wherein determining that the object is the object of interest of the user comprises determining, based on the gaze, that the user is gazing at a representation of the object displayed at the display.
Aspect 37. The method of aspect 36, wherein the display comprises a pass-through display configured to be positioned in a field of view of the user between the user and the scene.
Aspect 38. The method of aspect 37, wherein the pass-through display is part of at least one of: an extended reality (XR) system; or a handheld device.
Aspect 39. The method of any one of aspects 25 to 32, wherein determining that the object is the object of interest of the user comprises determining, based on the gaze, that the user is gazing at the object in the scene.
Aspect 40. The method of any one of aspects 25 to 39, further comprising initiating an action responsive to determining that the object is the object of interest of the user.
Aspect 41. The method of aspect 40, wherein the action is based on the object.
Aspect 42. The method of aspect 41, wherein the action is at least one of: translating text, wherein the object comprises the text; preparing a communication, wherein the object comprises contact information and the communication is based on the contact information; requesting data from a server, wherein the object comprises a barcode or a quick-response (QR) code and the requested data is based on the barcode or the QR code; identifying the object; or logging the object.
Aspect 43. The method of any one of aspects 40 to 42, wherein the action is initiated further responsive to an instruction from the user.
Aspect 44. The method of aspect 43, wherein the information displayed at the display comprises a prompt relative to the instruction.
Aspect 45. The method of aspect 44, further comprising interpreting, as the instruction, at least one of: a vocalization of the user; a hand gesture of the user; a head motion of the user; or an eye motion of the user.
Aspect 46. The method of any one of aspects 25 to 45, further comprising detecting a plurality of objects in the scene based on images of the scene.
Aspect 47. The method of any one of aspects 25 to 46, wherein the object is detected based on a list of interesting objects.
Aspect 48. The method of aspect 47, wherein the list of interesting objects comprises: text; contact information; a barcode; a quick response (QR) code; and an item of food.
Aspect 49. The method of aspect 48, wherein the text is in a target language.
Aspect 50. The method of aspect 48, wherein the list of interesting objects is user configurable.
Aspect 51. The device of aspect 24, wherein the text is in a target language.
Aspect 52. The device of aspect 24, wherein the list of interesting objects is user configurable.
Aspect 53. A non-transitory computer-readable storage medium having stored thereon instructions that, when executed by at least one processor, cause the at least one processor to perform operations according to any of aspects 25 to 50.
Aspect 54. An apparatus for providing virtual content for display, the apparatus comprising one or more means for perform operations according to any of aspects 25 to 50.
Aspect 55. A device for displaying information, the device comprising: at least one memory; and at least one processor coupled to the at least one memory and configured to: detect an object in an image of a scene obtained from a first camera; determine that a user is gazing at a representation of the object displayed at a display based on an image of the user obtained from a second camera; and based on determining that the user is gazing at the representation of the object displayed at the display, display, via the display, information associated with the object.
Aspect 56. The device of aspect 55, wherein the first camera comprises a scene-facing camera.
Aspect 57. The device of aspect 56, wherein the scene-facing camera is configured to capture images by default when the device is active.
Aspect 58. The device of any one of aspects 56 or 57, wherein the at least one processor is further configured to initiate an application that activates the scene-facing camera.
Aspect 59. The device of any one of aspects 55 to 58, wherein the second camera comprises a user-facing camera.
Aspect 60. The device of aspect 59, wherein the user-facing camera is configured to capture images by default when the device is active.
Aspect 61 The device of any one of aspects 59 or 60, wherein the at least one processor is further configured to initiate an application that activates the user-facing camera.
Aspect 62. The device of any one of aspects 55 to 61, wherein the at least one processor is further configured to initiate an application that activates at least one of the first camera or the second camera.
Aspect 63. The device of any one of aspects 55 to 62, wherein the device comprises a handheld device.
Aspect 64. The device of any one of aspects 55 to 63, wherein the device comprises the first camera, the second camera, and the display.
Aspect 65. The device of any one of aspects 55 to 64, wherein: the first camera is configured to capture a field of view of the scene; the display occupies a portion of a field of view of the user; and the field of view of the scene is different than the portion of the field of view of the user.
Aspect 66. The device of any one of aspects 55 to 65, wherein a line of sight between the user and the object is different than a line of sight between the user and the representation of the object displayed by the display.
Aspect 67. The device of any one of aspects 55 to 66, wherein the at least one processor is further configured to initiate an action responsive to determining that the object is the object of interest of the user.
Aspect 68. The device of aspect 67, wherein the action is based on the object.
Aspect 69. The device of aspect 68, wherein the action is at least one of: translating text, wherein the object comprises the text; preparing a communication, wherein the object comprises contact information and the communication is based on the contact information; requesting data from a server, wherein the object comprises a barcode or a quick-response (QR) code and the requested data is based on the barcode or the QR code; identifying the object; or logging the object.
Aspect 70. The device of any one of aspects 67 to 69, wherein the action is initiated further responsive to an instruction from the user.
Aspect 71. The device of aspect 70, wherein the information displayed at the display comprises a prompt relative to the instruction.
Aspect 72. The device of aspect 71, further comprising interpreting, as the instruction, at least one of: a vocalization of the user; a hand gesture of the user; a head motion of the user; or an eye motion of the user.
Aspect 73. The device of any one of aspects 55 to 72, wherein the at least one processor is further configured to detect a plurality of objects in the scene based on images of the scene.
Aspect 74. The device of any one of aspects 55 to 73, wherein the object is detected based on a list of interesting objects.
Aspect 75. The device of aspect 74, wherein the list of interesting objects comprises: text; contact information; a barcode; a quick response (QR) code; and an item of food.
Aspect 76. The device of aspect 75, wherein the text is in a target language.
Aspect 77. The device of any one of aspects 75 or 76, wherein the list of interesting objects is user configurable.
Aspect 78. A method for displaying information, the method comprising: detecting an object in an image of a scene obtained from a first camera of a device; detecting a gaze of a user relative to the scene based on an image of the user obtained from a second camera of the device; determining that the object is an object of interest of the user based on a relationship between the gaze of the user and the object; and based on determining that the object is the object of interest of the user, displaying, via a display of the device, information associated with the object.
Aspect 79. The method of aspect 78, further comprising initiating an action responsive to determining that the object is the object of interest of the user.
Aspect 80. The method of aspect 79, wherein the action is initiated further responsive to an instruction from the user.
Aspect 81. The method of aspect 80, further comprising interpreting, as the instruction, at least one of: a vocalization of the user; a hand gesture of the user; a head motion of the user; or an eye motion of the user.
Aspect 82. A method for displaying information, the method comprising: detecting an object in an image of a scene obtained from a first camera; determining that a user is gazing at a representation of the object displayed at a display based on an image of the user obtained from a second camera; and based on determining that the user is gazing at the representation of the object displayed at the display, displaying, via the display, information associated with the object.
Aspect 83. A non-transitory computer-readable storage medium having stored thereon instructions that, when executed by at least one processor, cause the at least one processor to perform operations according to any of aspects 25 to 50 or 78 to 82.
Aspect 84. An apparatus for providing virtual content for display, the apparatus comprising one or more means for perform operations according to any of aspects 25 to 50 or 78 to 82.

What is claimed is:

1. A device for displaying information, the device comprising:
at least one memory; and
at least one processor coupled to the at least one memory and configured to:
detect an object in an image of a scene obtained from a first camera;
determine that a user is gazing at a representation of the object displayed at a display based on an image of the user obtained from a second camera; and
based on determining that the user is gazing at the representation of the object displayed at the display, display, via the display, information associated with the object.

2. The device of claim 1, wherein the first camera comprises a scene-facing camera.

3. The device of claim 2, wherein the scene-facing camera is configured to capture images by default when the device is active.

4. The device of claim 2, wherein the at least one processor is further configured to initiate an application that activates the scene-facing camera.

5. The device of claim 1, wherein the second camera comprises a user-facing camera.

6. The device of claim 5, wherein the user-facing camera is configured to capture images by default when the device is active.

7. The device of claim 5, wherein the at least one processor is further configured to initiate an application that activates the user-facing camera.

8. The device of claim 1, wherein the at least one processor is further configured to initiate an application that activates at least one of the first camera or the second camera.

9. The device of claim 1, wherein the device comprises a handheld device.

10. The device of claim 1, wherein the device comprises the first camera, the second camera, and the display.

11. The device of claim 1, wherein:
the first camera is configured to capture a field of view of the scene;
the display occupies a portion of a field of view of the user; and
the field of view of the scene is different than the portion of the field of view of the user.

12. The device of claim 1, wherein a line of sight between the user and the object is different than a line of sight between the user and the representation of the object displayed by the display.

13. The device of claim 1, wherein the at least one processor is further configured to initiate an action responsive to determining that the object is the object of interest of the user.

14. The device of claim 13, wherein the action is based on the object.

15. The device of claim 14, wherein the action is at least one of:
translating text, wherein the object comprises the text;
preparing a communication, wherein the object comprises contact information and the communication is based on the contact information;
requesting data from a server, wherein the object comprises a barcode or a quick-response (QR) code and the requested data is based on the barcode or the QR code;
identifying the object; or
logging the object.

16. The device of claim 13, wherein the action is initiated further responsive to an instruction from the user.

17. The device of claim 16, wherein the information displayed at the display comprises a prompt relative to the instruction.

18. The device of claim 17, further comprising interpreting, as the instruction, at least one of:
a vocalization of the user;
a hand gesture of the user;
a head motion of the user; or
an eye motion of the user.

19. The device of claim 1, wherein the at least one processor is further configured to detect a plurality of objects in the scene based on images of the scene.

20. A method for displaying information, the method comprising:
detecting an object in an image of a scene obtained from a first camera;
determining that a user is gazing at a representation of the object displayed at a display based on an image of the user obtained from a second camera; and
based on determining that the user is gazing at the representation of the object displayed at the display, displaying, via the display, information associated with the object.
